(19) United States
(12) Patent Application Publication
(10) Pub. No.: US 2015/0332018 A1
(43) Pub. Date: Nov. 19, 2015

(54) SYSTEM AND METHOD FOR ORDERING DENTAL PROSTHETICS

(71) Applicants: Arnold Rosen, Boston, MA (US); James L. Richey, ACTON, MA (US)

(72) Inventors: Arnold Rosen, Boston, MA (US); James L. Richey, ACTON, MA (US)

(21) Appl. No.: 14/688,445

(22) Filed: Apr. 16, 2015

Related U.S. Application Data
(62) Division of application No. 13/044,448, filed on Mar. 9, 2011.
Application No. 13/044,448 is a continuation of application No. 12/231,067, filed on Aug. 28, 2008, now abandoned.
Application No. 12/231,067 is a continuation-in-part of application No. 11/623,087, filed on Jan. 14, 2007, now abandoned.
(60) Provisional application No. 60/759,830, filed on Jan. 17, 2006.

(51) Int. Cl. G06F 19/00

(52) U.S. Cl. CPC G06F 19/3456; G06F 19/3425

(57) ABSTRACT

A method and system of ordering a dental prosthetic from a dental laboratory, by which a prescription for a patient dental prosthetic is entered by a dentist, and stored and communicated to a dental laboratory. The receiving dental laboratory may subsequently communicate the dental prosthetic prescription to one or many authorized subcontracting laboratories and suppliers. The initiating dentist may seek collaborative guidance from one or many experts in the field of dental prosthetics. The experts are granted authorization to view the prescription data and communicate between each other and the dentist to provide the requested guidance.

### CROSS-REFERENCE TO RELATED APPLICATIONS

This application is a divisional of co-pending U.S. patent application Ser. No. 13/044,448 filed Mar. 9, 2011, the entire disclosure of which is hereby incorporated by reference, which is a continuation of U.S. patent application Ser. No. 12/231,067 filed Aug. 28, 2008, now abandoned, the entire disclosure of which is hereby incorporated by reference, which is a continuation-in-part under 37 C.F.R. §1.53(b) of U.S. patent application Ser. No. 11/623,087 filed Jan. 14, 2007 now abandoned, the entire disclosure of which is hereby incorporated by reference, which claims the benefit under 35 U.S.C. §119(e) of U.S. Provisional Application No. 60/759,830 filed Jan. 17, 2006, the entire disclosure of which is hereby incorporated by reference.

### STATEMENT REGARDING FEDERALLY SPONSORED RESEARCH OR DEVELOPMENT

This invention has been created without the sponsorship or funding of any federally sponsored research or development program.

### FIELD OF THE INVENTION

This invention is a involves an online system for managing the ordering and production of goods and services.

### BACKGROUND OF THE INVENTION

Prior systems for managing the ordering and production of goods and services have been characterized by inefficiency, a proneness to errors in communicating critical information among the parties, an inability to compartmentalize relevant information among various relevant parties, and difficulty in use.

These and other difficulties experienced with the prior art have been obviated in a novel manner by the present invention.

It is, therefore, an outstanding object of some embodiments of the present invention to provide a system for managing the ordering and production of goods and services in an efficient and effective manner.

Another object of some embodiments of the present invention is to provide a system for managing the ordering and production of goods and services online.

A further object of some embodiments of present invention is to provide a system for managing the ordering and production of goods and services that minimizes errors in communicating critical information among the parties.

It is another object of some embodiments of the present invention is to provide a system for managing the ordering and production of goods and services that has the ability to compartmentalize relevant information among various relevant parties.

It is a further object of some embodiments of the present invention to provide a system for managing the ordering and production of goods and services that is simple and easy to use by all relevant parties.

With these and other objects in view, as will be apparent to those skilled in the art, the invention resides in the combination of parts set forth in the specification and covered by the claims appended hereto, it being understood that changes in the precise embodiment of the invention herein disclosed may be made within the scope of what is claimed without departing from the spirit of the invention.

### BRIEF SUMMARY OF THE INVENTION

This invention is an online system by which a dentist prescribes and specifies a dental prosthetic device to be fabricated by one or more dental prosthetic laboratories. Some embodiments of the invention comprise a digital network including a plurality of elements, a server means communicatively connected to the network as an element, and adapted to place communication screens on the network to make them available to other elements on the network, said communications screens including an take-order screen including an takeorder form, a communication element on the network, adapted to present the takeorder screen and its takeorder form to the customer to be filled out with a definition of the product, and a communication element on the network, adapted to present the definition of the product to the manufacturer.

### BRIEF DESCRIPTION OF THE DRAWINGS

The character of the invention, however, may best be understood by reference to one of its structural forms, as illustrated by the accompanying drawings in which:

FIG. 1 shows a diagram of the general features of one embodiment of the present invention.

FIG. 2 shows the screen shot of the opening page for the dental prosthetic specification and fulfillment and dental practice management features.

FIG. 3 shows another screen shot which opens up the administrative section which includes various information.

FIG. 4 shows a screen shot of a typical prescription including various alphanumeric information and digital images of the case, including enlargement capability.

FIG. 5 shows a screen shot of another page which essentially is a form which requires of the dentist to enter the various critical information necessary to fulfill the prescription for the manufacture of a dental product

FIG. 6 shows another screen shot of another page in the prescription entry process.

FIG. 7 is another screen shot showing another prescription entry page including a complete guided entry of data critical to cost and case planning

FIG. 8, to the left, shows the screen shot of the page which uploads the order, and to the right, shows a typical uploaded order page including dental images of the case.

FIG. 9 is a screen shot showing the uploading of color images associated with a particular case.

FIG. 10 shows a screen shot showing a completed case planning document.

FIG. 11 shows a screen shot of a before and after imaging service in which the before-procedure smile image is portrayed adjacent the after-procedure smile image.

FIG. 12 is a screen shot of a menu of available options provided by an embodiment of the present invention.

FIG. 13 is a screen shot of a list of look-up tables each of which provides the dentist with a selection of possible entries associated with the name of the lookup table.

FIG. 14 is a screen shot showing a list of default variables generally applied to each case unless specifically changed by the appropriate authority.

FIG. 15 is a screen shot of a form used to produce a report based on the data which is stored in the server

FIG. 16 is a screen shot of a log-in screen for the individual dentist to get access to his records.

FIG. 17 shows a screen shot of a system database of patient information useful for the dentist.

FIG. 18 is a screen shot of a data entry and modification screen that allows the dentist to modify his patient records that are online.

FIG. 19 shows a screen shot of the various images associated with a particular patient and a particular project.

FIG. 20 represents the network of practitioners who could use the system of the present invention to provide multi-disciplinary care to a particular patient and a particular case.

FIG. 21 shows a typical X-RAY digital image based communication by which a sending dentist is able to communicate with a receiving dentist' in order to obtain an opinion about a particular case, through a network embodying the principles of the present invention.

FIG. 22 shows a screen shot of a typical laboratory entrance screen that welcomes the customer dentist to the laboratories portion of the network of the present invention.

FIG. 23 shows a diagrammatic representation of the manner in which the individual dentist conducts a two-way communication with the server of the present invention and then two-way communication is established with the dental laboratory.

FIG. 24 shows a series of screen shot welcome pages representing large dental institutions and dental practice groups who might be involved in the system of the present invention.

FIG. 25 shows a diagrammatic representation of a feature which may be incorporated into some embodiments of this invention.

FIG. 26 represents a figurative presentation of the concept of the present invention in which it functions as an “information highway” linking multiple dentists working in multiple locations and working with multiple labs and allows any permutation or combination of the various parties to communicate effectively with one-another to accomplish the efficient and successful production of the necessary dental products and services.

FIG. 27 represents a further representation of the concept of the dental superhighway in which any of multiple dentists working in multiple locations can communicate through the system server and onward to any of many available dental laboratories so that the individual dentists have unfettered options to work with any particular laboratory for any particular case.

FIG. 28 is a representation of the concept that, using at least one embodiment of the present invention, it is possible for multiple dentists working in multiple locations and working with multiple labs and subcontractors to function in real time in order to achieve the most efficient and effective level of dental service.

FIG. 29 shows a representation of an embodiment of the present invention which includes dentist and laboratory integration and integrated outsourcing.

FIG. 30 describes the trend of large scale group of dental labs which might be appropriate to be integrated into the current invention.

FIG. 31 shows a screen shot representing an inquiry screen that might be used to recover information from the network of an embodiment of the present invention.

FIG. 32 shows a screen shot that allows a person to determine financial information about their account on the network of an embodiment of the present invention,

FIG. 33 is a screen shot showing information about various dental product projects that are covered by an embodiment of the system of the present invention and shown in its database.

FIG. 34 is a screen shot showing a form useful in soliciting information from the database of an embodiment of the current invention including instructions concerning how the answer is to be delivered to the requestor.

FIG. 35 is a representation of the manner in which the system of the present invention can be integrated with additional outsourcing capabilities.

FIG. 36 lists a number of features that may be incorporated into the various embodiments of the present invention.

FIG. 37 represents the feature of some embodiments of the present invention in which the system allows the use of a paperless dental practices working in multiple locations and working with multiple labs in real time.

FIG. 38 represents the totally integrated information highway for a dental practice.

FIG. 39 lists various dental practice management features that may be incorporated into the various embodiments of the present invention.

FIG. 40 lists various dental lab management features that may be incorporated into the various embodiments of the present invention.

FIG. 41 shows the various steps and features that can be used by a large dental lab group (designated LDLG), employing the system as a data entry application.

FIG. 42, and serial FIGS. 42A-42F, shows a flow chart of a specific embodiment of the principles of the present invention, particularly developed to manage the preparation of dental prostheses.

### DETAILED DESCRIPTION OF THE INVENTION

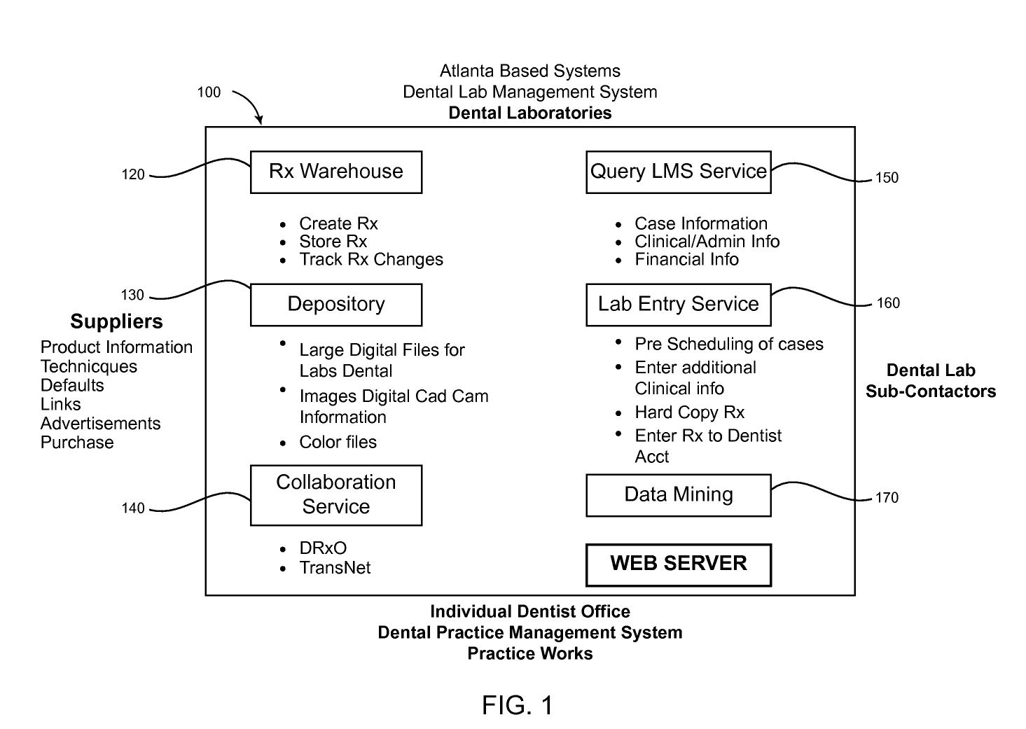

In reference to FIG. 1, a network based system 100 is shown which is configured to provide:
Rx (Prescription) Warehouse Services 120 including Create RX service, Rx Storage
Service and Service to track Rx Changes;
Depository Services 130 comprising data storage of digital files for labs (laboratories), dental images, digital CAD/CAM information and digital color files;
Collaboration Services 140;
Query LMS (Laboratory Management Services) 150 comprising case Information, clinical information, administrator Information and financial Information;
Lab Entry Services 160 comprising pre-scheduling of cases, entering additional case information, producing hard copy of prescriptions, entering prescriptions to dentist account;
Data mining services 170.

The present invention involves an Internet application that allows computer networks to improve outcomes and productivity in the production of medical products. The system contemplates two primary functions. First, the system would provide an efficient and effective network linking all dentists and dental laboratories, (primary and sub contract labs). Second, it would provide a host and depository for data management for all physicians (dentists, oral surgeons, etc.) and all dental laboratories.

The basic systems that are embodiments of the present invention may be either a point-to-point (one professional to one laboratory) or a fan out (one laboratory to all of its dentist-customers, and sub-contracting laboratories). Another embodiment of the invention is a multipoint enterprise solution. The basic system may be only being used by one lab directly to only their customers (physicians and sub-contracted labs). Another embodiment of the invention allows multiple doctors and/or dentists and laboratories, using multiple accounts from multiple locations' to process multiple prescriptions to multiple supplier laboratories, as opposed to just one doctor sending one prescription to one lab only.

The term ‘prescription’ means a set of instructions that request and define a product to be manufactured by a manufacturer or laboratory’ The term “medical prescription” means a set of instructions that request and define a medical product (e.g., a dental product) to be manufactured by a medical laboratory (e.g., a dental lab) for a specific patient. The term “web based” means a system that resides on the Internet and functions as a service site or a software system that resides at both the user's site (either laboratories or physicians) and the Internet that interacts together either constantly or as required by the overall system.

The claimed system basic process is a web based software/service system.

The claimed system utilizes a web-based system to provide services and software to physicians (e.g., dental practitioners, oral surgeons). The claimed system could be set up to handle only one laboratory. The claimed system could be set up to handle a network of numerous ordering parties, numerous accounts, numerous physician locations, numerous laboratories, and numerous other sources. The claimed system could utilize a questionnaire process to create prescriptions or instructions (e.g. dental prescriptions, implant treatment planning, etc.) that include necessary information needed to manufacture laboratory products (e.g., dental laboratory products) for patients.

Other features that may be present in a Section 1 or the questionnaire portion of the various embodiments of the present invention could be described as follows.

When any laboratory (e.g. dental lab) is a participant in the claimed system the questionnaire displayed to the physicians (e.g., dentists) for that specific lab can be uniquely tailored, by the lab, to that lab's specific offerings. These changes are lab controlled and can be instantly changed at any time

When any laboratory (e.g., dental lab) is a participant in the claimed system, then laboratories can initially enter a prescription in the claimed system rather than the physician. In this instance a physician-selected laboratory enters into the claimed system a prescription generated by the physician. The prescription is either generated by the physician using the claimed system or another method and the laboratory does the entry using the claimed system for the purpose of acquiring all the benefits of the claimed system.

The primary laboratory may also use the claimed system to regenerate prescriptions as the initiator of a new prescription for the purpose of subcontracting work to other laboratories. In this instance the claimed system acting as a depository for data, showing the primary laboratory selected information to the sub-contractor as if the primary laboratory was the original initiator of the work requirement.

When any laboratory (e.g., dental lab) is a participant in the claimed system, then laboratories can interface their software system to the web based software system for bidirectional data exchange (e.g., manufacturing information, costs, product availability, payables, credit card payments, shipping information, etc.) for the benefit the appropriate claimed system users.

When any laboratory (e.g., dental lab) is a participant in the claimed system, additional collaboration communications between physicians and laboratories for implant treatment planning using a questionnaire process to create prescriptions and/or instructions that include necessary information needed to manufacture laboratory products (e.g., dental laboratory products) and the corresponding clinical procedures required by the physicians for improved implant results.

When any laboratory (e.g. dental lab) is a participant in the claimed system, the questionnaire can be modified by individual laboratories (e.g., dental laboratories) to include default answers to specific questions on the questionnaire that are laboratory-preferred answers. if the physician (e.g., dentist) does not choose an answer for that question then the lab preferred default answer is provided.

When any laboratory (e.g., dental lab) is a participant in the claimed system, the questionnaire can be modified and used by individual laboratories (e.g. dental labs) to expand a Dental Prescription to include both additional as well as necessary information, not initially supplied by the physician, (e.g. dentist) that the laboratory (e.g., dental lab) needs, or wants added, in order to manufacture the requested product.

when any laboratory (e.g., dental lab) is a participant in the claimed system and they choose to interface their software system to the web based software system additional proprietary information may be added to the prescription information necessary for the manufacture of the product at their individual laboratory that is not reflected back to the original physician on the original prescription (e.g. sub-contract information, proprietary process information, etc.).

Answers to the questionnaire can be pre-selected by individual physicians (e.g. dentists) prior to a Dental Prescription being created that reflect the physician's (e.g. dentist's) individual initial preferences to specific questions. These answers will be automatically used as default answers on Dental Prescriptions. Questions on the questionnaire can be changed at the time the Dental Prescription is being created to reflect a physician's (e.g., dentist's) change of his preference at that time.

Dental Prescriptions that are modified and/or expanded to include both additional as well as necessary information, not initially supplied by the physician, are required to have the physician's (e.g., dentist's) final approval to verify all information is correct before the questionnaire is marked as completed for manufacture.

Dental Prescriptions that are re-generated using the claimed system initiated by the laboratory from a physician's prescription that has been created by the physician using any method or prescriptions created using the claimed system and/or modified and/or expanded to include both additional as well as necessary information, not initially supplied by the physician, are required to have the physician's (e.g., dentist's) final approval to verify all information is correct before the questionnaire is marked as completed for manufacture.

Dental Prescription Codes are alphanumeric data numbers generated by completing questionnaires by either physicians (e.g., dentists) or laboratories (e.g. dental lab) related to either standard or laboratory modified questionnaires.

Answers to the questionnaire can be reduced to an alphanumeric data string (Dental Prescription Code-DPS) or created as a hard copy for transmission storage, and processing purposes.

Questionnaires can be either standard or modified by individual laboratories (e.g., dental labs) and as such DPS strings are encoded and decoded by each individual laboratory's (e.g. dental lab) specific modifications.

DPS alphanumeric data decode revision information for the specific laboratory is included in the DPS string.

Questionnaire questions have alphanumeric designators for each question displayed on questionnaire screens or pages, which are used to cross reference answers from individual laboratory prescription sheets to the claimed system questionnaire.

Other features that may be present in Section 1 or the Healthcare process and record management portion of the various embodiments of the present invention could be described as follows:

The claimed system site provides dentists and labs with multiple password protected accounts. This allows multiple physicians (e.g. dentists) or Laboratories to use one or multiple accounts to request multiple work orders (in the form of a dental prescription created by a claimed system Questionnaire process) from multiple labs.

The claimed system provides a system linking multiple dentists acting as a group or individually with multiple laboratories (e.g. dental labs). The process provides for individual laboratories (e.g. dental labs) to customize their identification and questionnaire screens for their individual laboratories (e.g., dental labs) thus customizing identification, services, and products offered by their laboratory (e. g. dental lab).

The claimed system may store and archive individual dental prescription information, (created by the questionnaire), for physicians (e.g. dentists) and laboratories (e.g., dental labs) for data mining purposes.

The claimed system may store and archive individual dental data information, (created by the laboratory in a shared bi-directional data interface), for physicians (e.g., dentists) and laboratories (e.g., dental labs) for data mining purposes.

The claimed system may allow individual labs to add additional information to dental prescriptions received from physicians (e.g., dentists) necessary for the lab to make products. These prescription changes and additions are then processed for the ordering physician's (e.g., dentist's) approval.

The claimed system may allow individual laboratories who choose to interface their software system to the web based software system to add additional proprietary information to the prescription information necessary for the manufacture of the product at their individual laboratory that is not reflected back to the original physician on the original prescription (e.g. sub contract information, proprietary process information, etc.).

The claimed system may allow creation, editing, storage, and/or retrieval of data records and information of account activity linking multiple physicians (e.g. dentists) acting as a group or individually using single or multiple accounts transmitting data records and information to multiple labs, all retrievable by authorized physicians (e.g., dentists).

The claimed system may allow creation, editing, storage, and/or retrieval of data records and information of account activity linking multiple dentists acting as a group or individually using single or multiple accounts transmitting data records and information to individual labs retrievable by laboratories (e.g., dental labs).

Referring to FIG. 1, the center block symbolizes the system web server in the network, typically the Internet. The web server provides prescription warehouse services including the functionality for creation of the prescriptions, storing of the prescriptions and tracking of the prescription changes—There is also a depository for large digital files of dental photographs and x-ray images, CAD/CAM information and color files. There are also collaborative services—There are query LMS services including case information, clinical and administrative information, and financial information. There are lab entry services, including pre-scheduling of cases, entry of additional clinical information, hard copy prescriptions and ability to enter prescriptions to the dentists' accounts. Finally there is a data mining facility. Above the hub server are the network connections to the dental laboratories that produce the dental products and appliances. The interface contacts the dental laboratories and then integrates with the dental lab management system.

To the right are the interfaces to the dental lab subcontractors who perform specific services for the dental labs and for other elements of the system

Below the web server is the interface for individual dentist offices including interface with the dental office management system and dental practice management programs.'

To the left are the various suppliers that are able to provide product information, techniques, defaults, links, advertisements and purchase information interfaced to the web server and therefore accessible to all of the other members of this system.

All of these aspects are essentially integrated online by some embodiments of the present invention and all parties can communicate with each other as required.

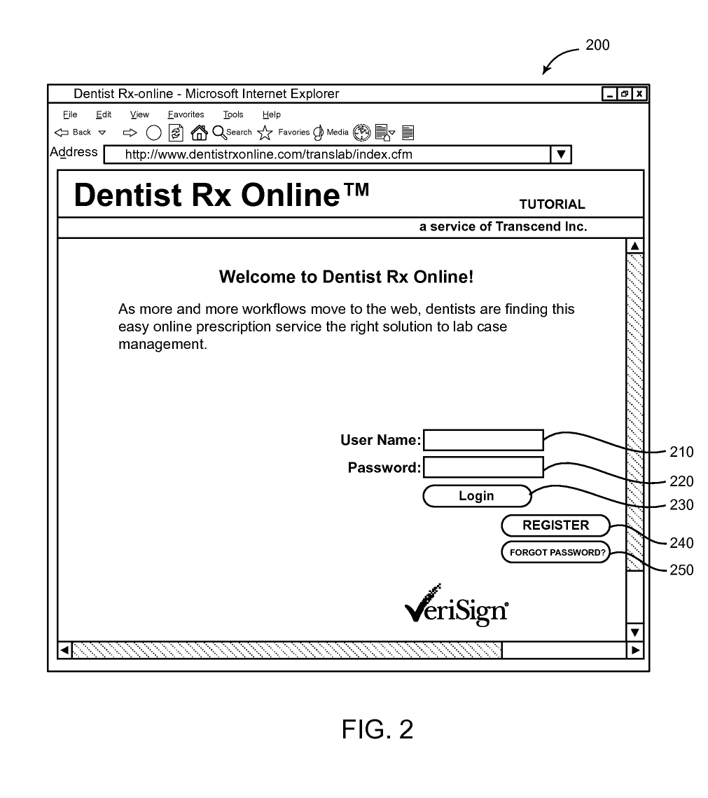

In reference to FIG. 2, the system 100 is configured to display screen 200 to a user and accepts the entry of: User Name 210, Password 220 fields to facilitate functions accessed by clicking the following buttons; Login 230, Registration 240, Forgot Password 250.

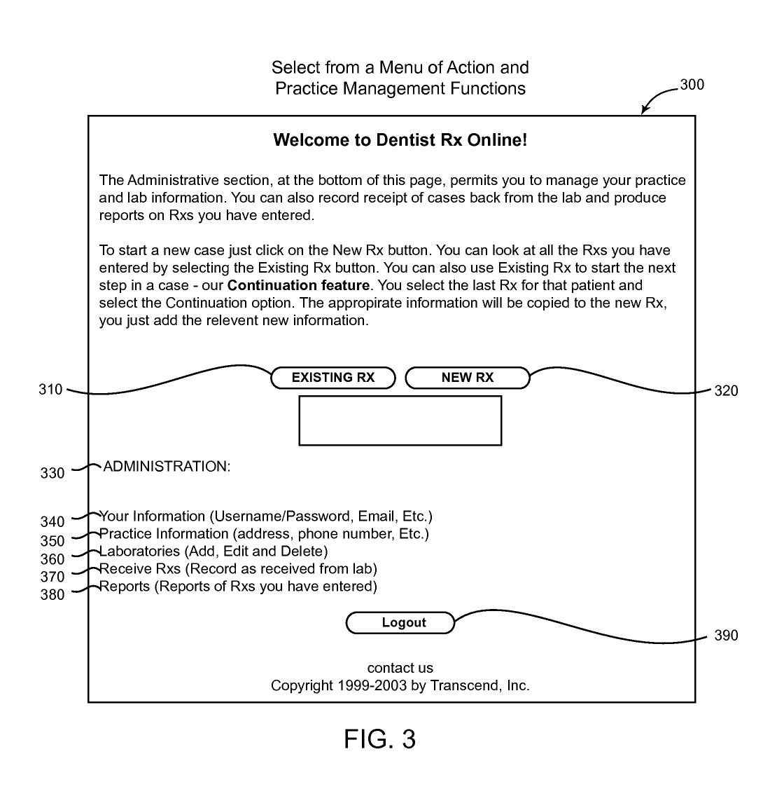

In reference to FIG. 3, the system 100 is configured to display a screen 300 to a user which contains the following buttons to retrieve data for: existing Rx 310, new Rx 320. A user may logout of the system utilizing the Logout button 390. A user may also choose to execute system administrative functions by selecting one of the following links:
Your Information (username/password, email, Etc.) 340;
Practice Information (address, phone number, Etc.) 350;
Laboratories (Add, Edit and Delete) 360;
Receive Rxs (Record as received from lab) 370;
Reports (Reports of Rxs you have entered) 380.

The existing prescription link takes the dentist to prescriptions that he has already entered and that are in process. The new prescription link is provided to open up a new project.

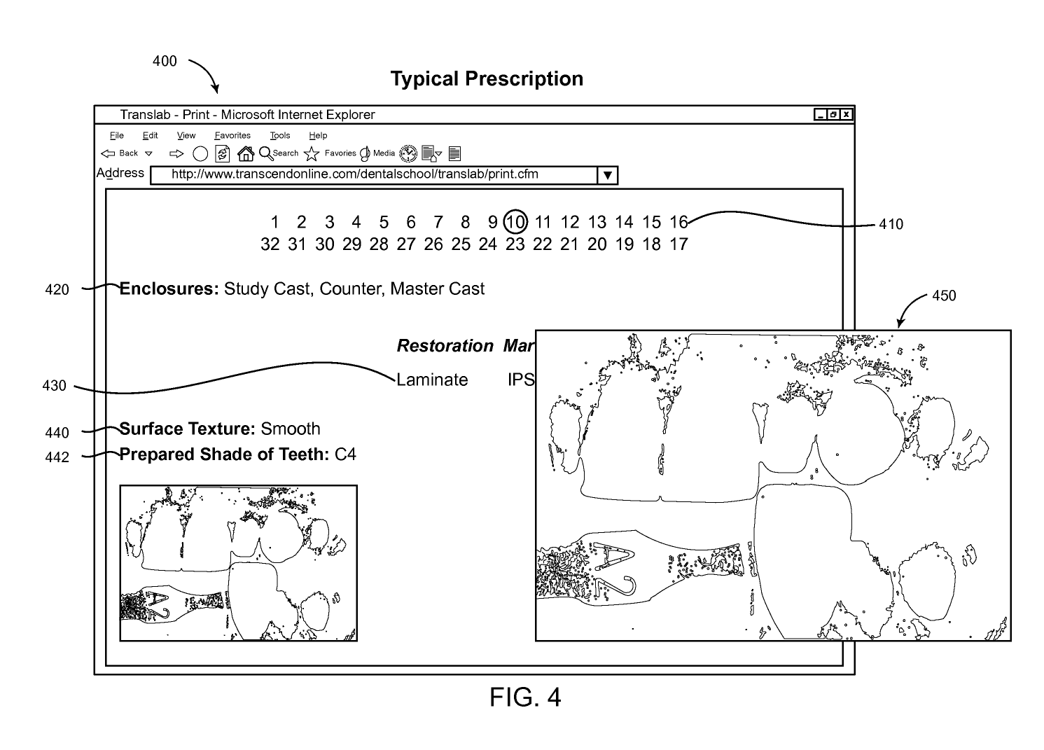

In reference to FIG. 4, the system 100 is configured to display screen 400 which is a representation of the data content of a typical Prescription being comprised of the Patient Teeth Affected 410, itemization of Enclosure 420, Restoration Type data 430, Surface Texture 440, Prepared Shade of Teeth 442, one or more than one images of; the patients teeth and mouth and other images 450.

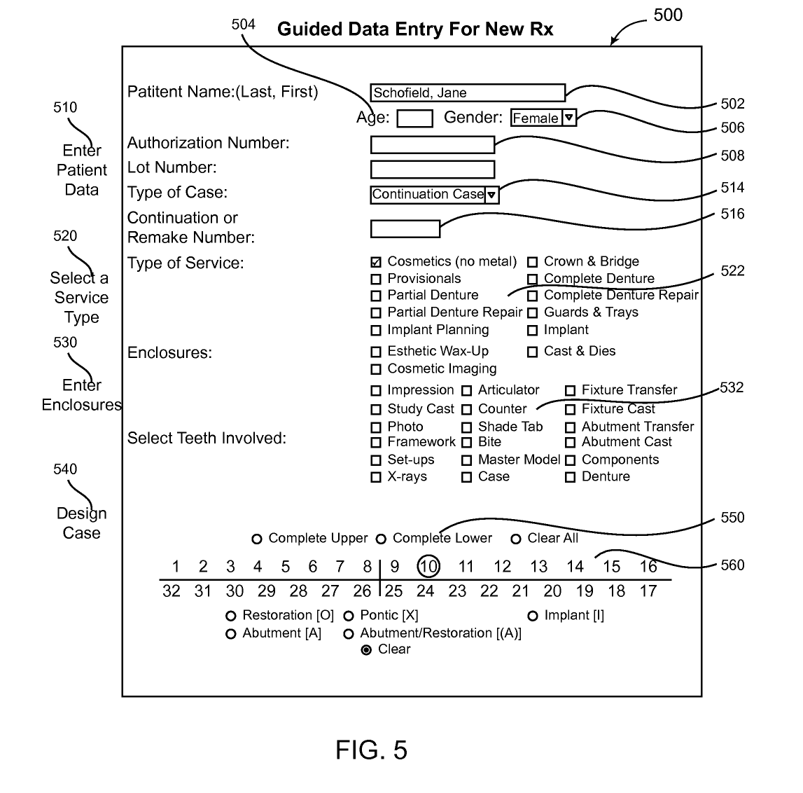

In reference to FIG. 5, the system 100 is configured to display screen 500 which enables a user to be guided to enter the patient data for a new prescription comprised of: patient name 502, Age 504, Gender 506, Authorization Number 508, Lot Number 510, Type of Case 512, Confirmation or Remake Number 514. A user is further guided to select a Service Type 522, Enter Enclosures 532, and Design Case 540.

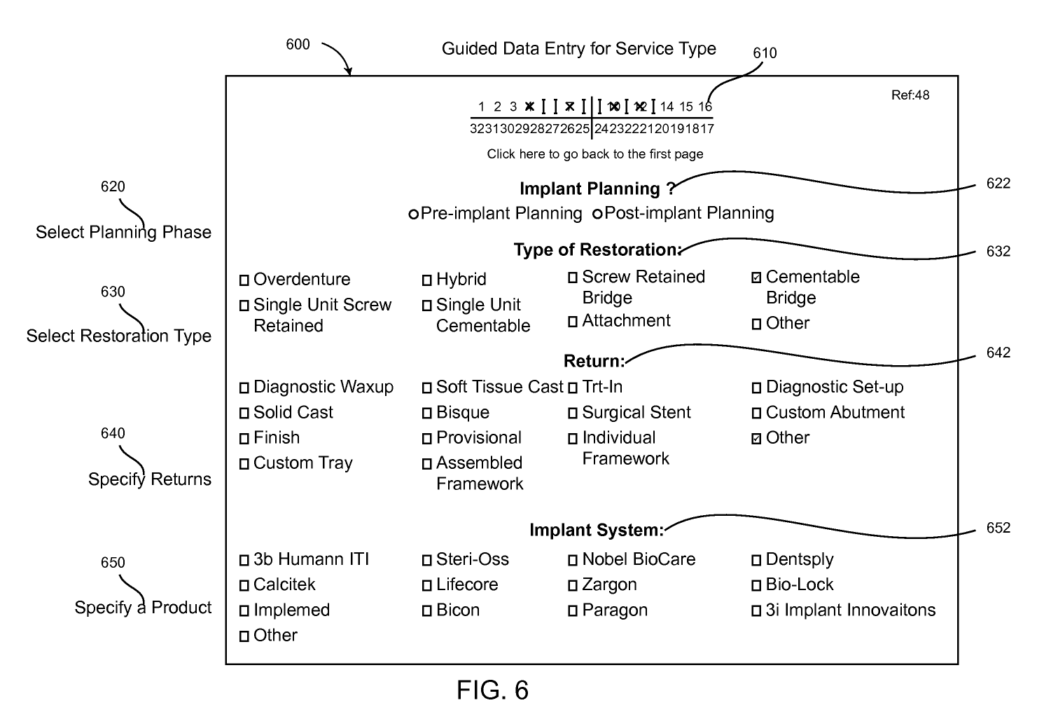

In reference to FIG. 6, the system 100 is configured to display a screen 600 which enables a user to be guided to enter data for the case service type comprised of Graphical Representation of Patient Teeth to be treated 610, guided data choices for; Implant Planning 622, Type of Restoration 632, Returns 642, Implant System 652.

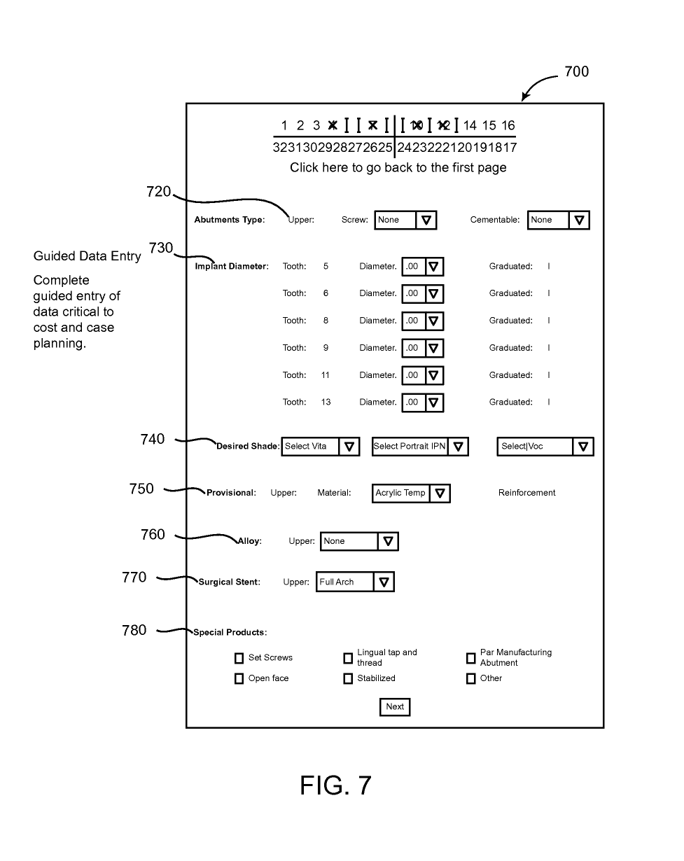

In reference to FIG. 7, the system 100 is configured to display a screen 700 which enables a user to enter guided data critical to cost and case planning comprised of Graphical Representation of Patient Teeth to be treated 710, Abutment types 720, Implant Diameter for each patient tooth to be treated 730, Desired Shade 740, Provisional 750, Alloy 760, Surgical Stent 770, Special Products 780.

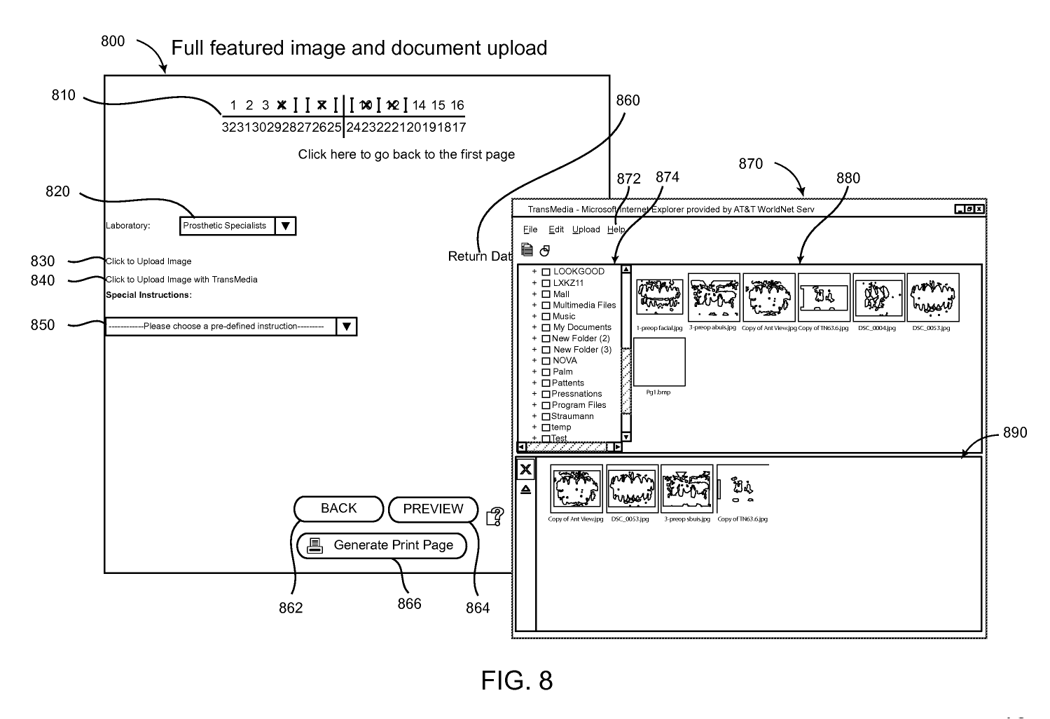

In reference to FIG. 8, the system 100 is configured to display a screen 800 which enables a user to enter the data required to direct the system to upload images and documents of the prescription. The data fields and links are comprised of a Graphical Representation of Patient Teeth to be treated 810, Laboratory 820, Special Instructions 850, Return Date 860, Click to Upload Image 830 link, Click to Upload Image with TransMedia 840. A second screen 870 is shown which contains a menu bar 872 to further control the uploading of various documents and images 880, 890.

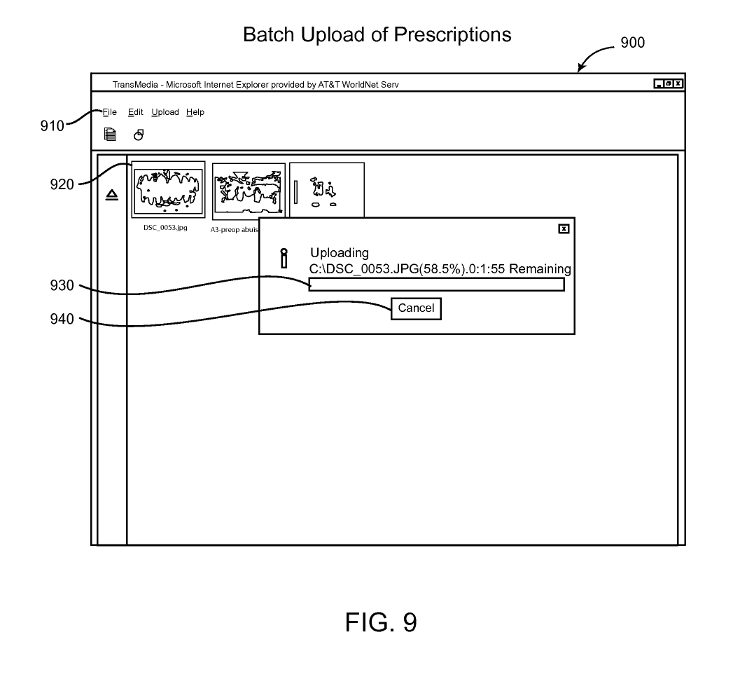

In reference to FIG. 9, the system 100 is configured to display a screen 900 to a user which provides a menu bar 910 of actions to be taken to direct the system 100 to upload batches of Prescription data and images 920. The progress of the operation is shown by a status bar 930. The operation may be cancelled by clicking the Cancel button 930.

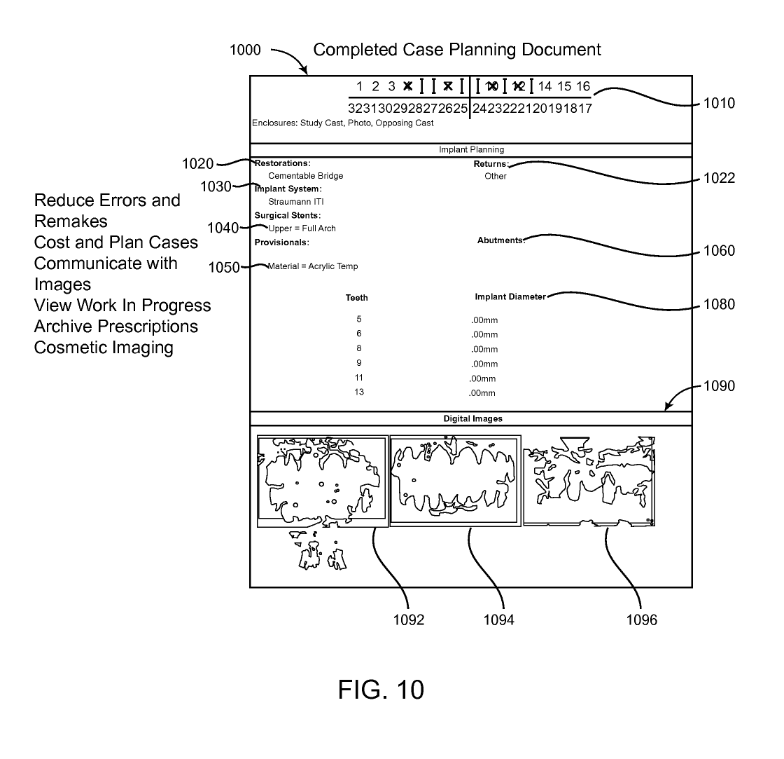

In reference to FIG. 10, the system 100 is configured to display a screen 1000 which enables a user to be guided to retrieve a Completed Case Planning Document comprised of Graphical Representation of Patient Teeth to be treated 1010, Restorations 1020, Returns 1022, Implant Systems 1030, Surgical Stents 1040, Provisionals 1050, Abutments 1060, Teeth 1070 and the associated Implant Diameter 1080 of Teeth 1070B, Digital Image 1092, Digital Image 1094, Digital Image 1096. This document assists to: reduce errors and remakes, Cost and plan cases, Communicate with images, view work in progress, Archive prescriptions and utilize Cosmetic imaging.

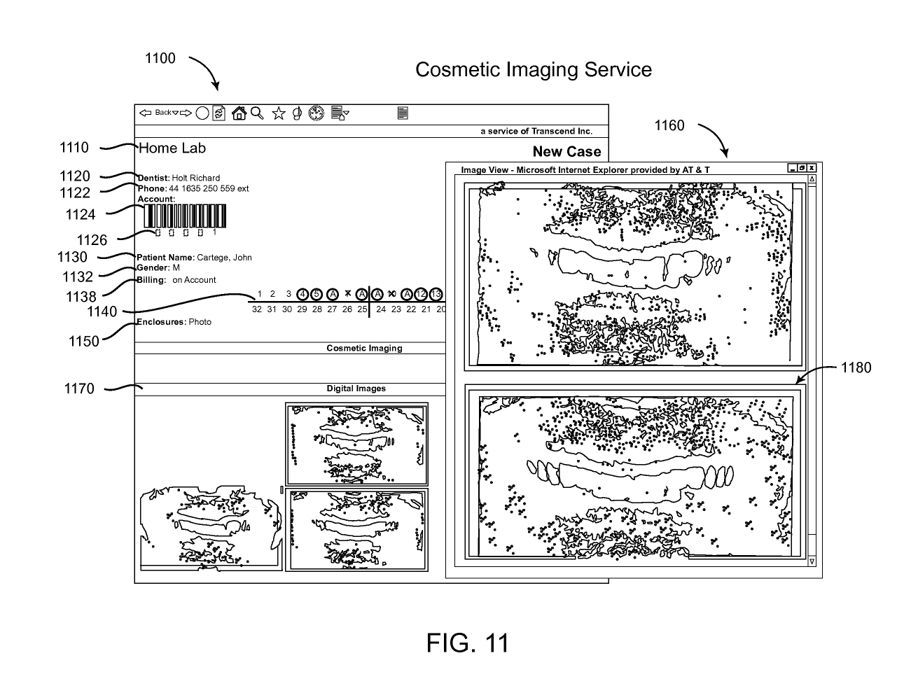

FIG. 11 shows a screen shot of a before and after imaging service in which the before-procedure smile image is portrayed adjacent the after-procedure smile image. The display can be real, with the after-image showing the actual result. It could also be hypothetical, with the after image being the expected result. In the hypothetical case, the after effect is created using computer simulation. This hypothetical cosmetic imaging service provides the patient with an opportunity to see how the results of the medical procedure will affect the look of their smile, prior to actually agreeing to the process. In further reference to FIG. 11, the system 100 is configured to display screen 1100 containing Cosmetic Imaging Service data comprised of: Laboratory Name 1110, Dentist Name 1120, Dentist Phone #1122, Dentist Account Bar Code 1124, Dentist Account Number 1126, Patient Name 1130, Patient Gender 1132, Billing Type data 1138, Graphic representation of Teeth affected 1140, Description of Enclosures 1150, Digital Cosmetic Before Treatment Image 1160, Digital Additional Patient mouth images 1170 Digital Cosmetic After Treatment Image 1180.

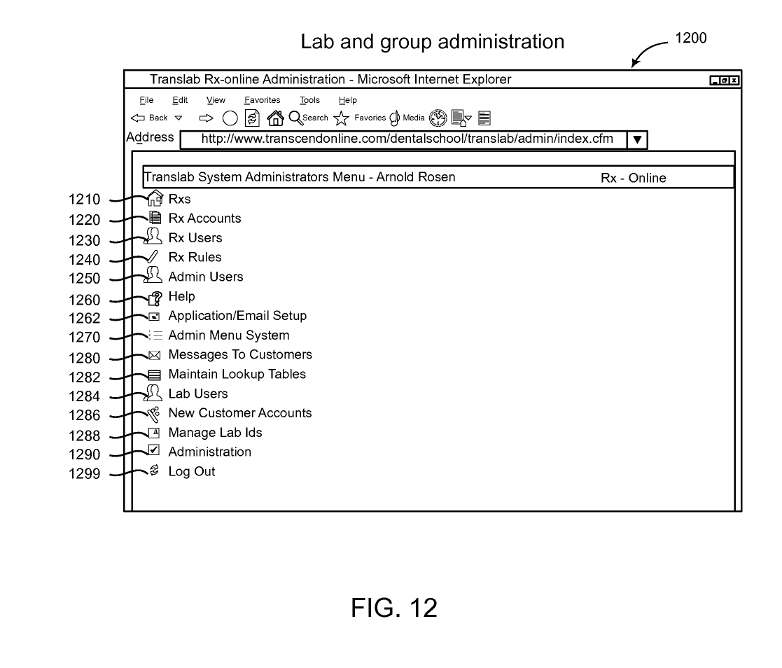

In reference to FIG. 12, the system 100 is configured to display a screen 1200 comprised of links to execute the following Lab and Group Administration actions:
Administer Rxs 1210;
Add and change. Rx Accounts 1220;
Add and change. Rx Users 1230;
Add new and change existing Rx Rules 1240;
Add and edit Administrative Users 1250;
Retrieve Help on system functions 1260;
Perform Application/Email Setup 1262;
Administer Menu System 1270;

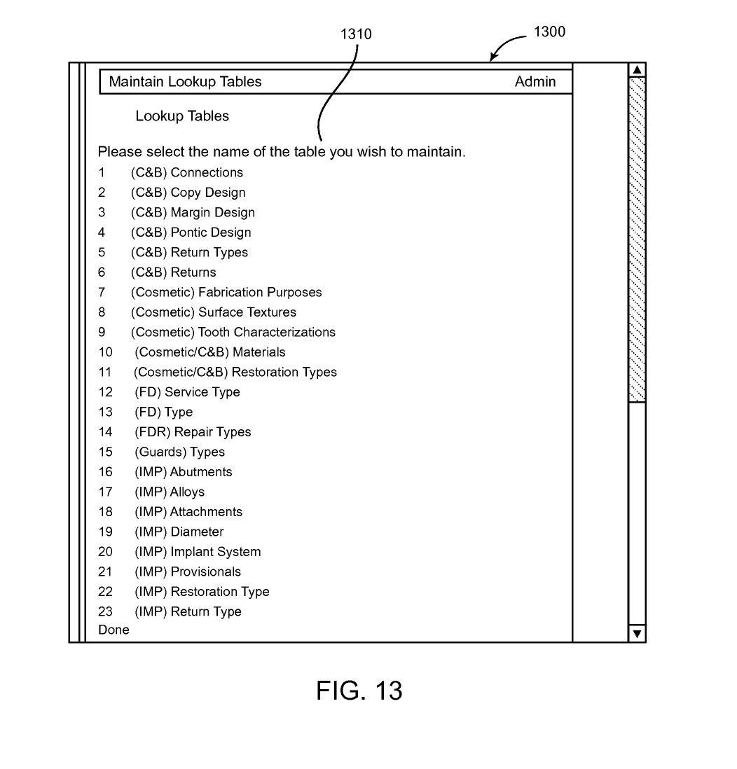

In reference to FIG. 13, the system 100 is configured to display a screen 1300 with a list of selections of tables which a user chooses to maintain preferences.

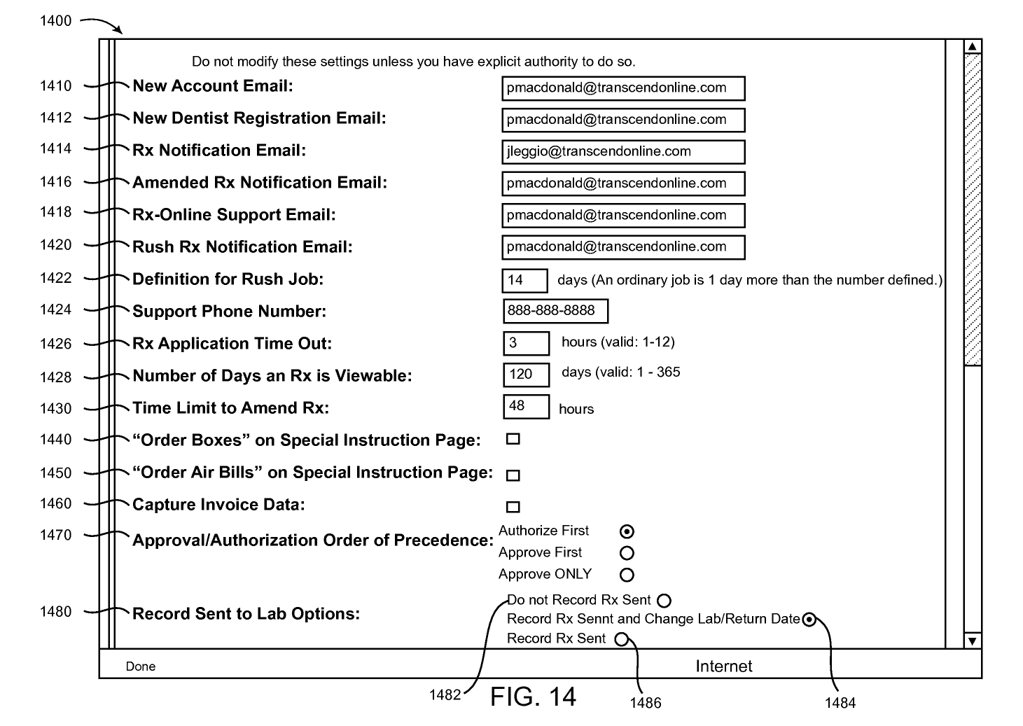

In reference to FIG. 14, the system 100 is configured to display a screen 1400 with a display of fields and options with which a user enters data to control system functions and communications, comprised of:
New Account Email 1410,
New Dentist Registration Email 1412,
Rx Notification Email 1414,
Amended Rx Notification Email 1416,
Rx-Online Support Email 1418,
Rush Rx Notification Email 1420,
Definition for Rush Job (days) 1422,
Support Phone Number 1424,
Rx Application Time Out 1426,
Number of Days an Rx is Viewable 1428,
Time Limit to Amend Rx 1430,
“Order Boxes” on Special Instruction Page check box 1440,
“Order Air Bills” on Special Instruction Page check box 1450,
Capture Invoice Data check box 1460,
Approval/Authorization Order of Preference Option buttons 1470,
Record Sent to Lab Options option buttons 1480.

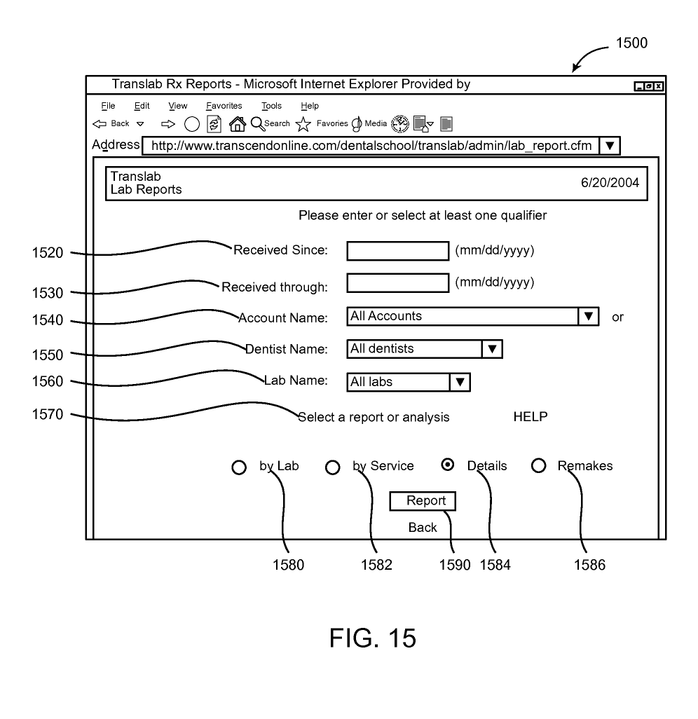

In reference to FIG. 15, the system 100 displays a screen 1500 to a user which permits the user, as part of the system's query services, to retrieve archived reports and data based on a variety of entered parameters comprising Received since date 1520, Received through date 1530, Account name 1540, Dentist name 1550, and Lab name 1560. The summary level and category of the data to be retrieved is further controlled by selecting options comprising: by Lab 1580, by Service 1582, by Details 1584 or by Remake category 1586.

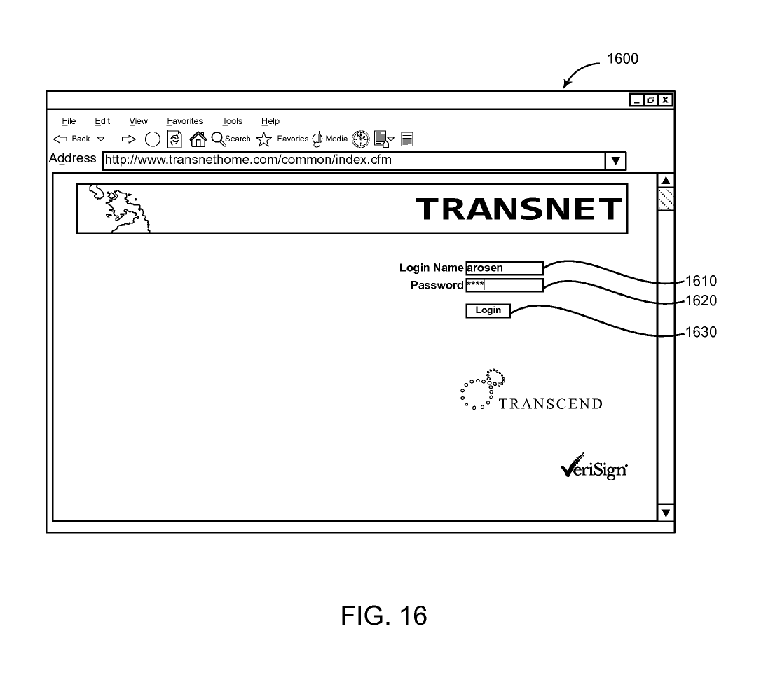

In reference to FIG. 16, the system 100 is configured to display a screen 1600 to allow a user to login to the system service for uploading files, documents and images.

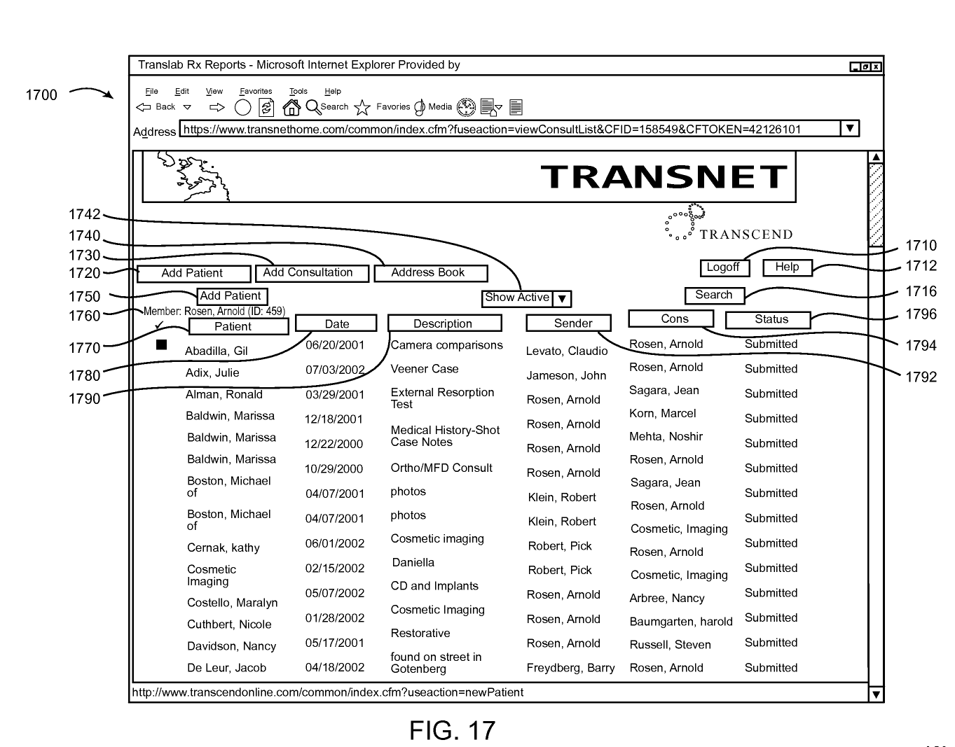

In reference to FIG. 17, the system 100 is configured to display a screen 1700 which enables a user to add a patient to a consultation data record and to view consultation data based on a Member Id 1760 retained by the system at login. This view was the result of making a selection in the selection list box 1742. System actions are taken by clicking buttons comprised of; Logoff 1710, Help 1712, Search 1716, Add Patient 1720, Add Consultation 1730, Address book 1740. The action selected, in this instance adding patient data, is shown in text box 1750. Data relevant to the consultation record is displayed and is comprised of: Patient 1770, Date 1780, Description 1790, Sender 1792, Consultant 1794, and Status 1796. This is one step of the collaboration process in which data is shared between dentists and other experts through the system.

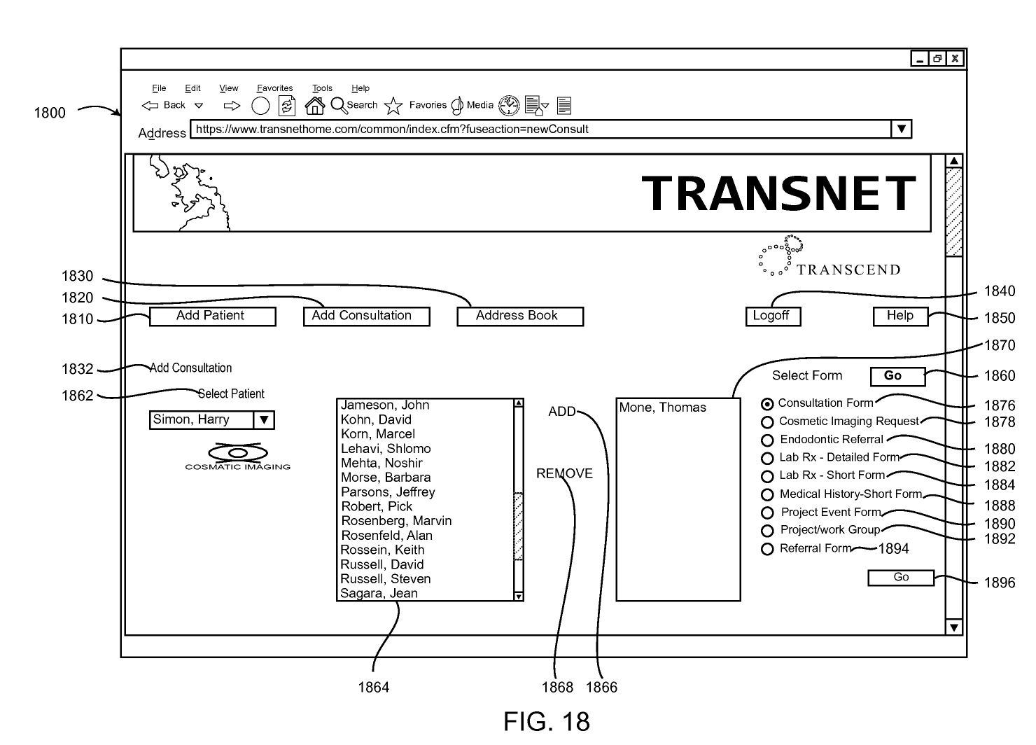

In reference to FIG. 18, the system 100 is configured to display a screen 1800 which enables a user to add a consultant to the consultation data and to view consultation data. System actions are taken by clicking buttons comprised of; Add Patient 1810, Add Consultation 1820, Address Book 1830, Logoff 1840, Help 1850, Go 1860 or alternatively, Go 1896. System actions are also specified by use of a Select Patient select list 1862, the Forward to Selection list 1864, an ADD arrow 1866, a REMOVE arrow 1868, and a Forward to Selection selected list 1870., The use of the Forward To and the Forward to Selection in conjunction with the add and remove arrows control which experts will be receive requests for collaborative consultation. The system actions are further specified by clicking one of the Select Form options comprised of: Consultation Form 1876, Cosmetic Imaging Request 1878, Endodontic Referral 1880, Lab Rx-Detailed Form 1882, Lab Rx - Short Form 1884 , Medical History Short Form 1888, Project Event Form 1890, Project/Work Group 1892, Referral Form 1894.

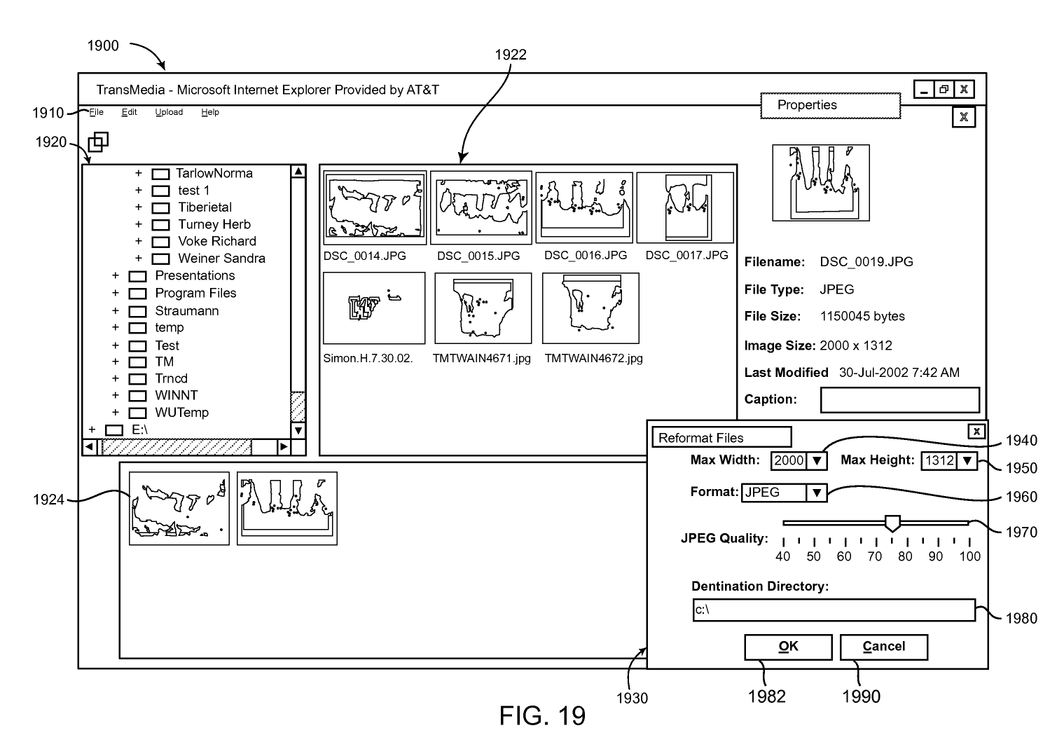

In reference to FIG. 19, the system 100 is configured to display a screen 1900 which provides a menu bar 1910 of actions to be taken by a user to direct the system 100 to upload batches of image files selected from a file directory tree 1920. Images files from the folder are displayed in screen frame 1922. An image file 1924 is selected for reformatting. The parameters of a file selected to be reformatted are entered in screen window 1930 and are parameters comprising: Max Width 1940, Max Height 1950, Format Selection List box 1960, JPEG Quality slider control 1970, Destination Directory text box 1980. The reformat operation is initiated by clicking an OK button 1982 and may be cancelled by clicking a Cancel button 1990.

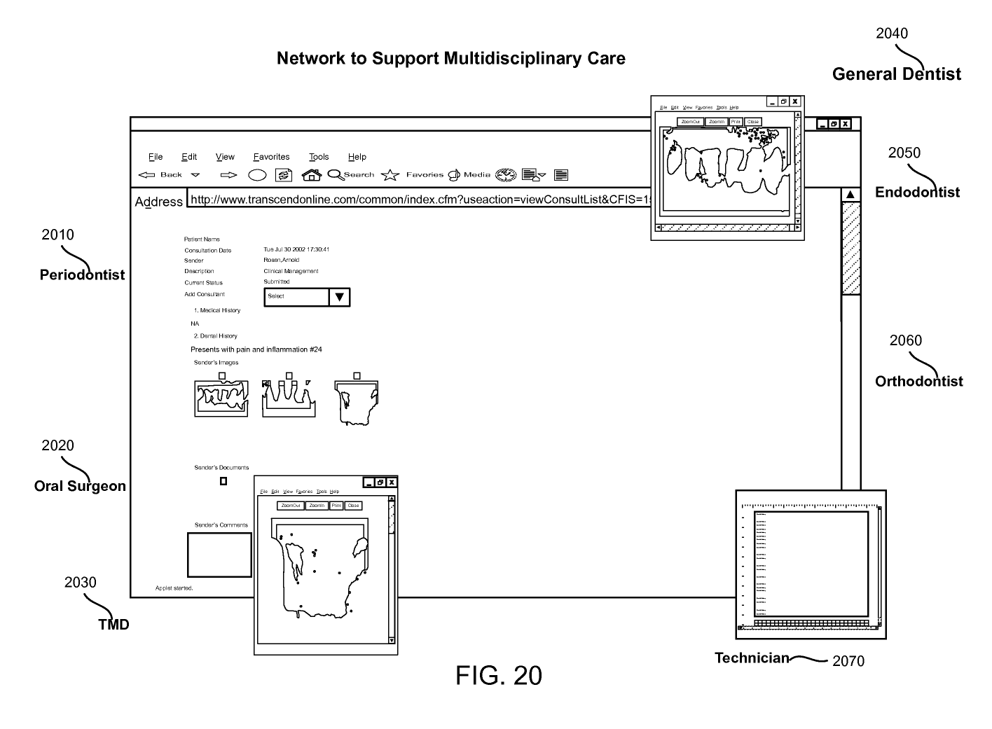

In reference to FIG. 20, the system 100 is configured to provide a communication network to permit the participation in multidisciplinary care of dental experts comprising: General Dentists, Endodontists, Periodontists, Orthodontists, Oral Surgeons, TMD experts and Technician experts.

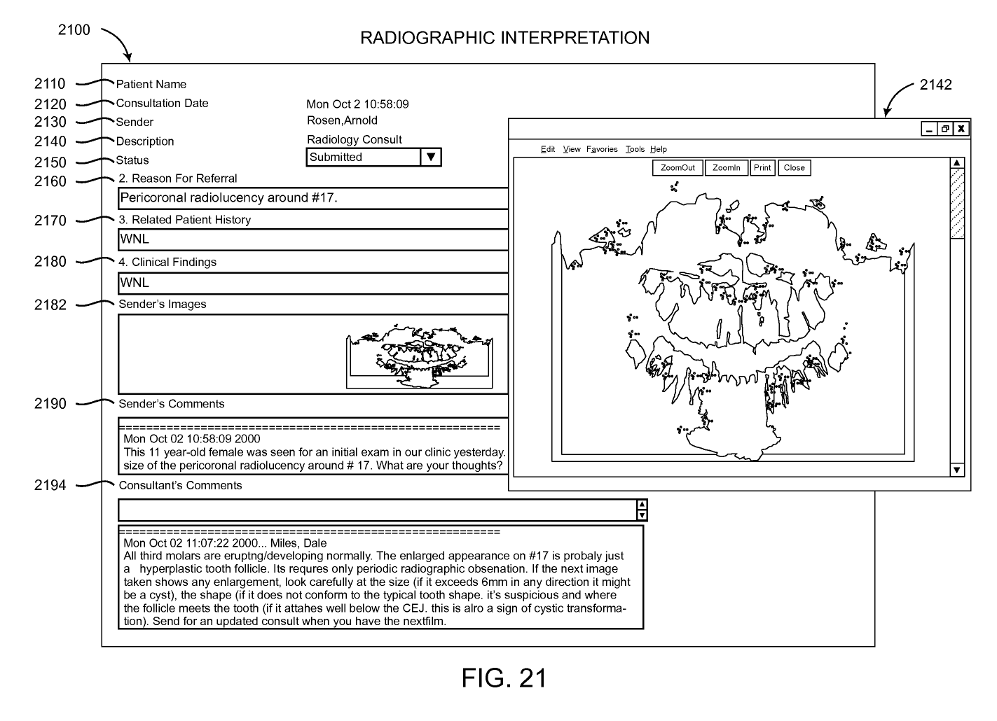

In reference to FIG. 21, the system 100 is configured to display to a user, a screen 2100 which is representative of the enablement of collaboration between a dentist and a consultant for an interpretation by the consultant of a patient's radiographic image 2142. Other data presented on screen 2100 is comprised of Patient Name 2110, Consultation Date 2120, Sender 2130, Description 2140, Status 2150, Reasons for Referral 2160, Related Patient History 2170, Clinical Findings 2180, Sender's Images 2182, Sender's Comments 2190, and Consultant's Comments 2194. What is demonstrated is the system's ability to facilitate the communication of a dental physician's request for assistance to an expert consultant, the consultant's response and the associated data and images for both the request and the response.

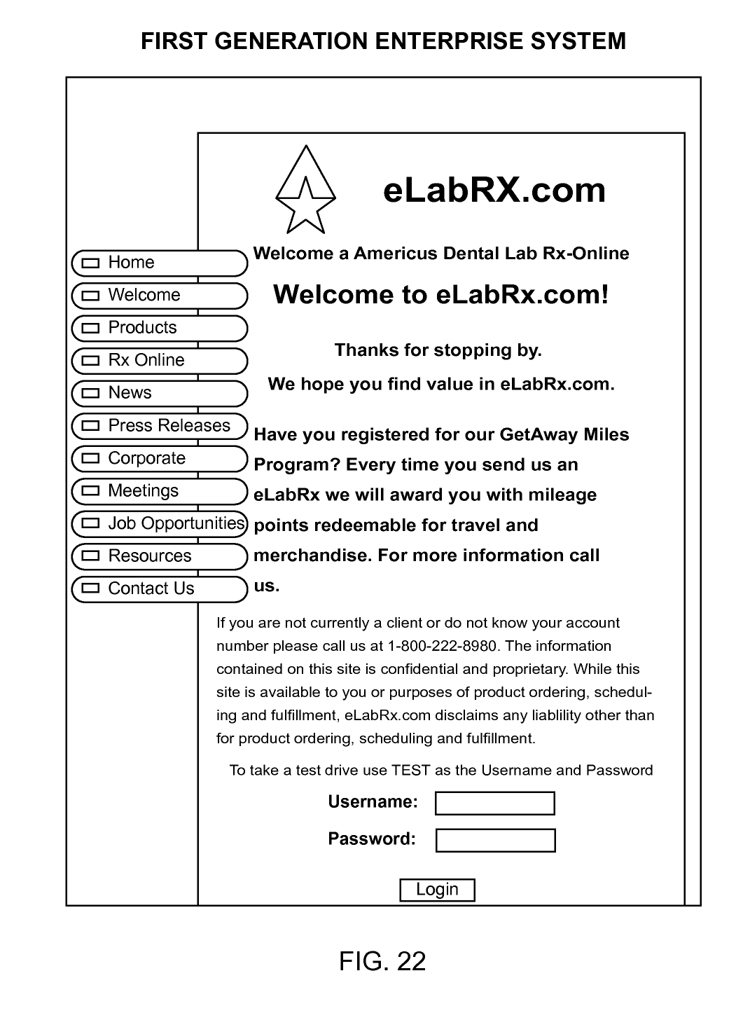

In reference to FIG. 22, the system 100 is configured to display a screen which is the welcome page for a laboratory's user.

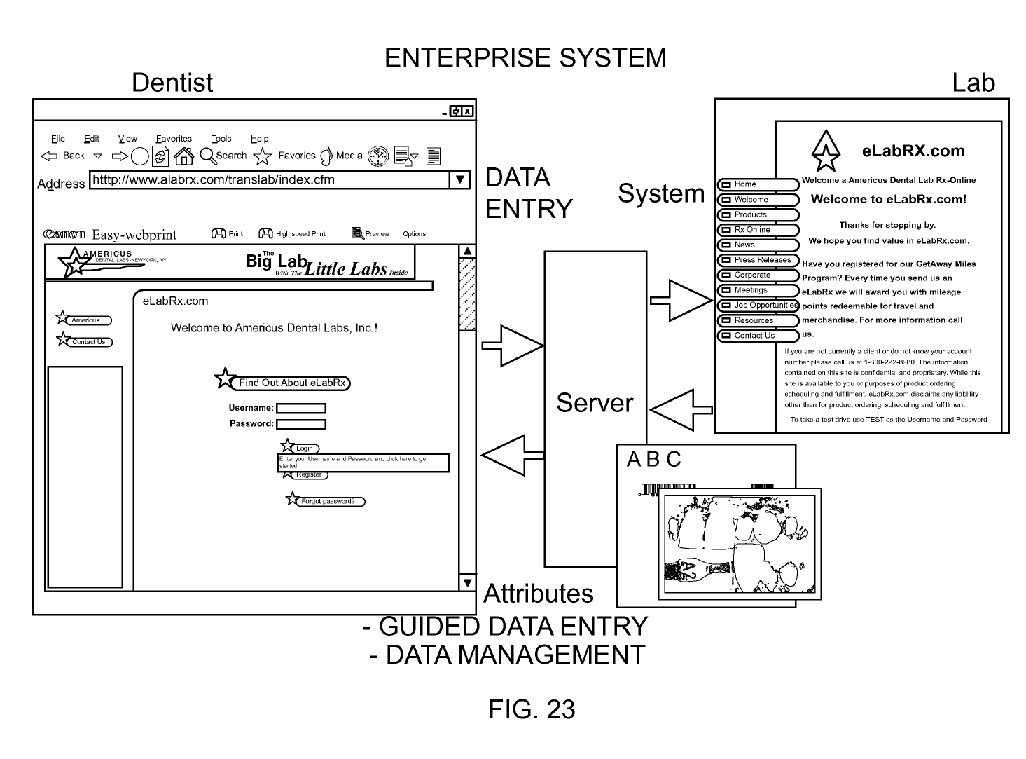

FIG. 23 shows a diagrammatic representation of the manner in which the individual dentist conducts a two-way communication with the server of the present invention and then two-way communication is established with the dental laboratory. This allows the dentist and the lab to conduct extremely efficient and effective communication in order to accomplish a particular task. In some embodiments of the present invention, the key attributes are that the data is very carefully guided by forms which minimize the work involved in entering the data and which controls the existence and accuracy of the data and data management which maintains the data and keeps it organized in a highly efficient and effective manner.

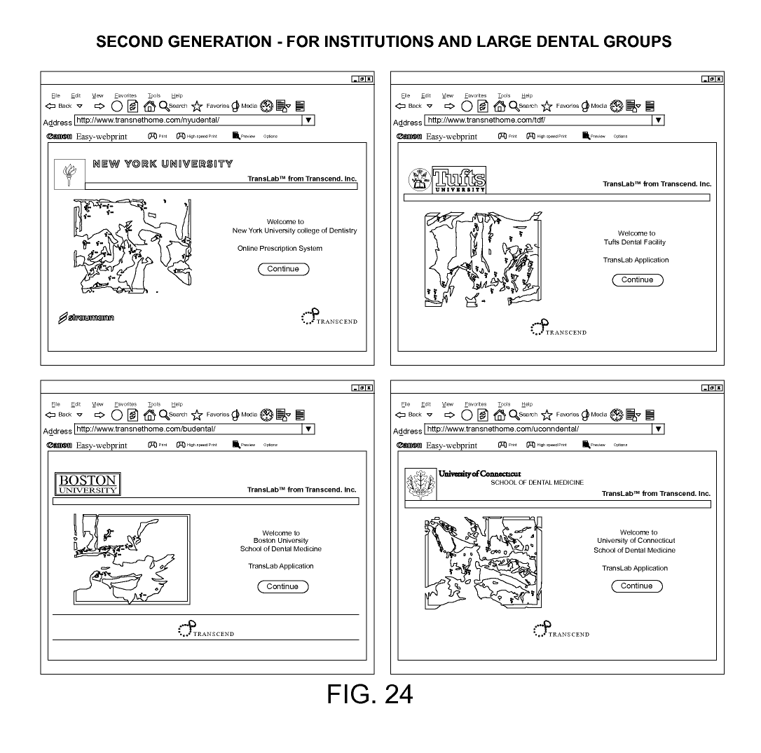

FIG. 24 shows a series of screen shot welcome pages representing large dental institutions and dental practice groups who might be involved in the system of the present invention.

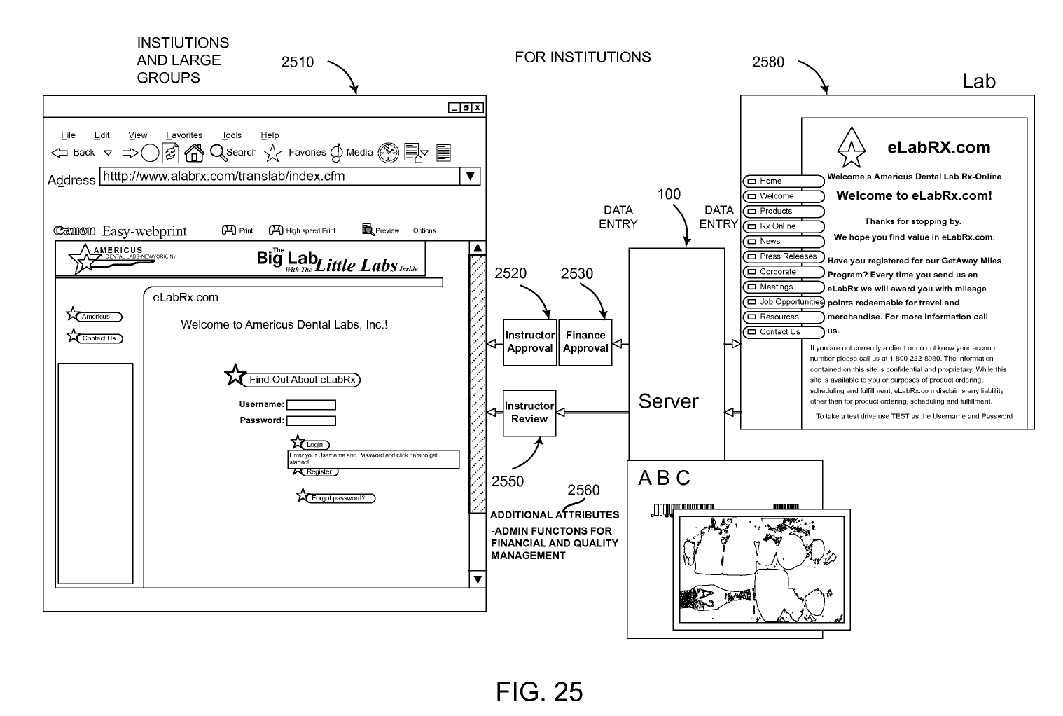

In reference to FIG. 25, the system provides functionality for institutions for instructor review, instructor approval and financial approval and is another embodiment of the collaborative capabilities provided by the system.

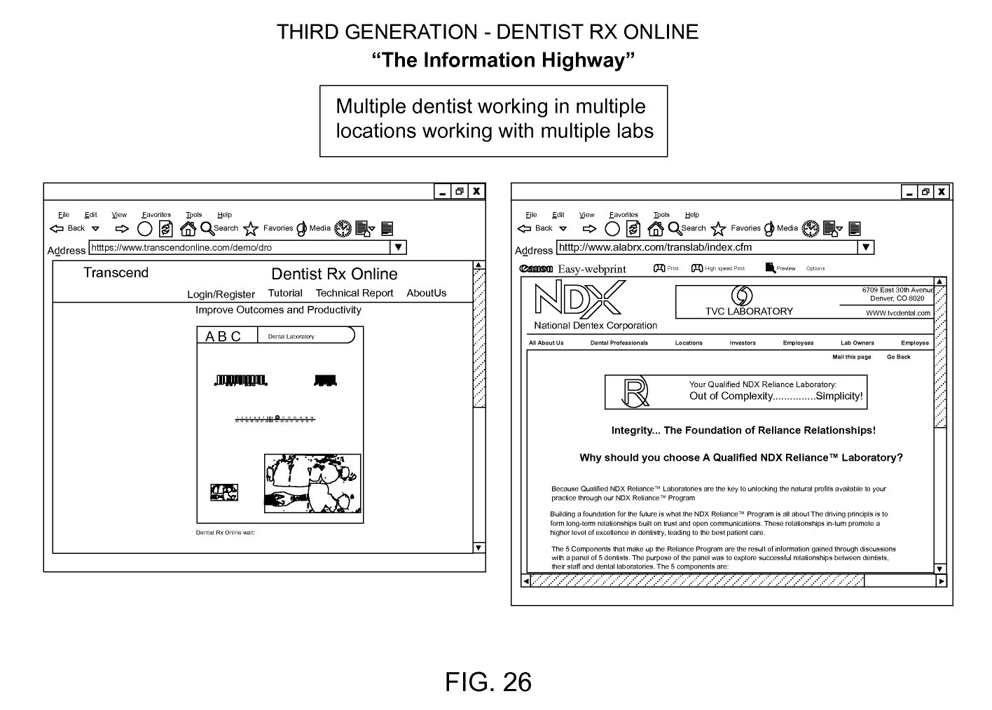

FIG. 26 represents a figurative presentation of the concept of the present invention in which it functions as an “information highway” linking multiple dentists working in multiple locations and working with multiple labs and allows any permutation or combination of the various parties to communicate effectively with one another to accomplish the efficient and successful production of the necessary dental products and services.

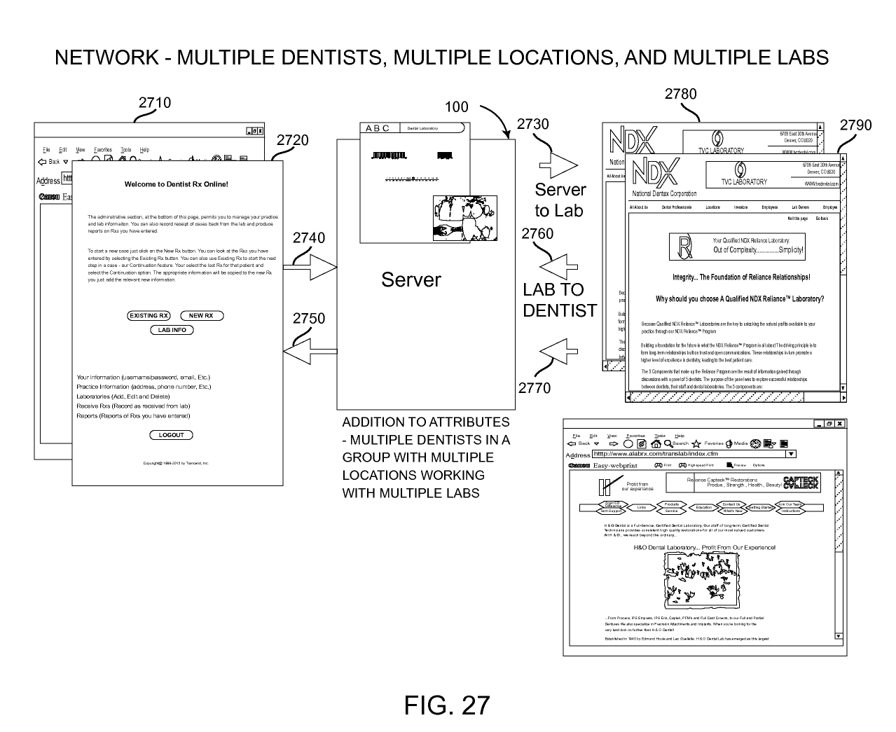

In reference to FIG. 27, a network of multiple dentists, referenced by 2710 and 2720, are enabled by the system 100 to have authorized access to the system services of multiple laboratories referenced by 2780 and 2790. In this embodiment, the system 100 is configured to enable dentist to laboratory, dentist to system 2740, system to dentist 2750, system to laboratory 2760, and laboratory to dentist 2770 communication.

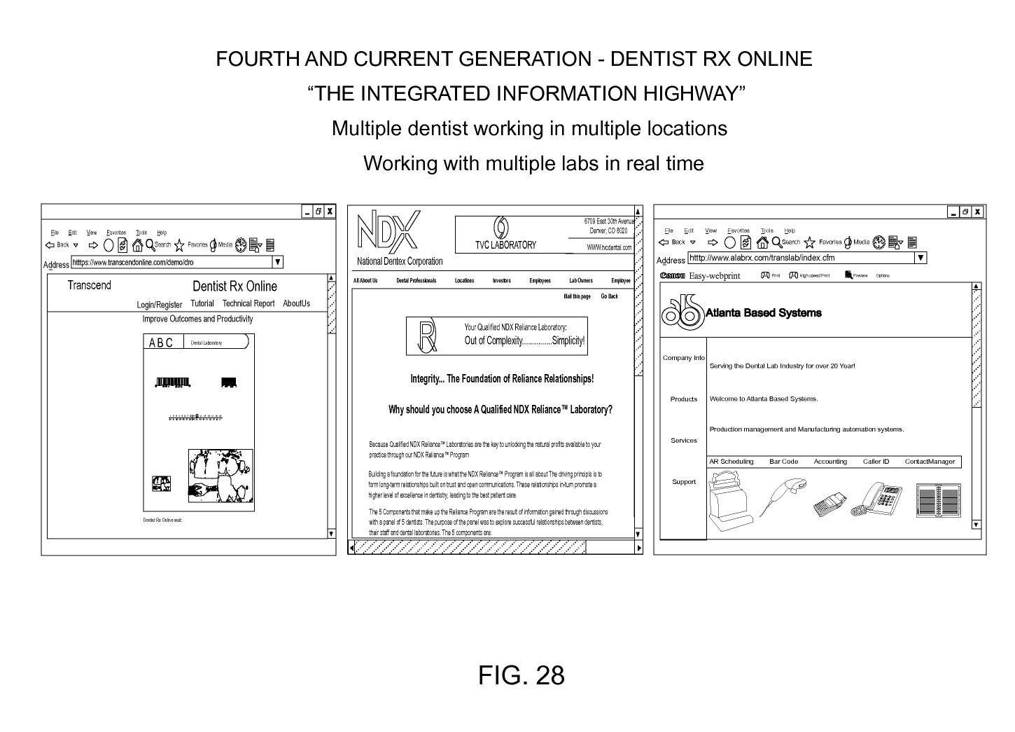

FIG. 28 is a representation of the concept that, using at least one embodiment of the present invention, it is possible for multiple dentists working in multiple locations and working with multiple labs and subcontractors to function in real time in order to achieve the most efficient and effective level of dental service.

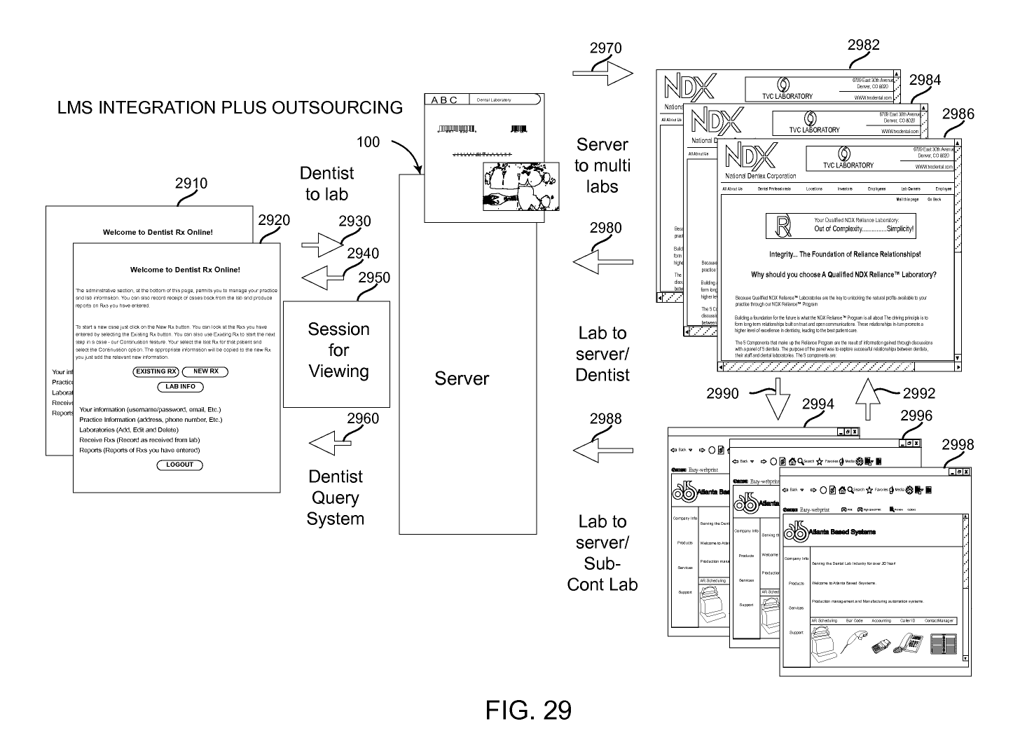

In reference to FIG. 29, a network of multiple dentists (as referenced by 2900 and 2902) are enabled by the system 100 to have authorized access to the system services of multiple laboratories as referenced by 2920, 2922 and 2924. In addition the system enables the multiple laboratories to authorize access to system services to laboratory subcontractors as referenced by 2950, 2952, and 2954.

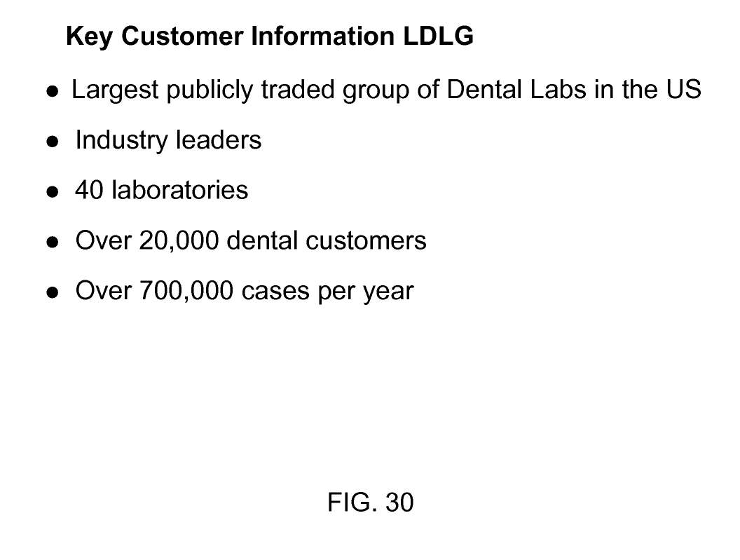

FIG. 30 describes the trend of large scale group of dental labs which might be appropriate to be integrated into the current invention. The large dental lab group is designated LDLG.

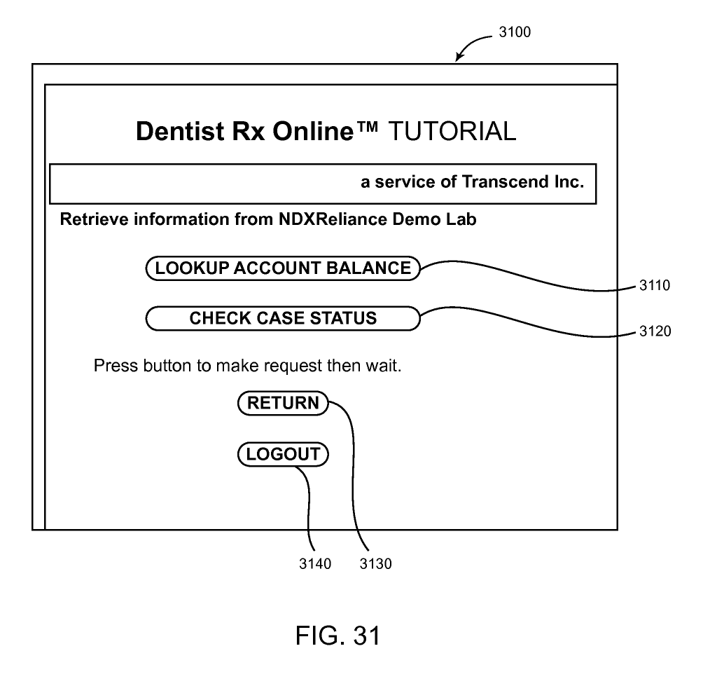

In reference to FIG. 31, the system 100 is configured to display Screen 3100 to a user which enables a user to retrieve financial and case information comprising: account financial status data 3110 and the data relevant to the status of a particular case 3120 (e.g. prescription).

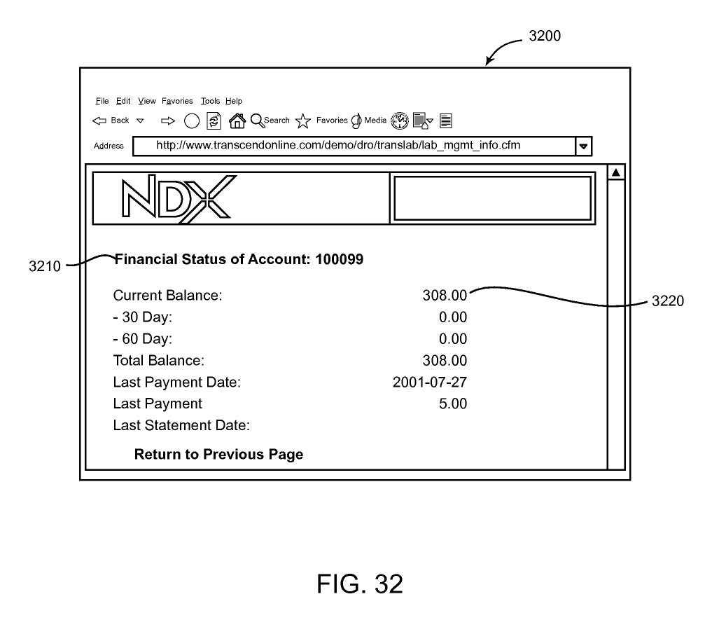

In reference to FIG. 32, the system 100 is configured to display Screen 3200 to a user which reveals additional account financial data 3220 for a specific account number 3210.

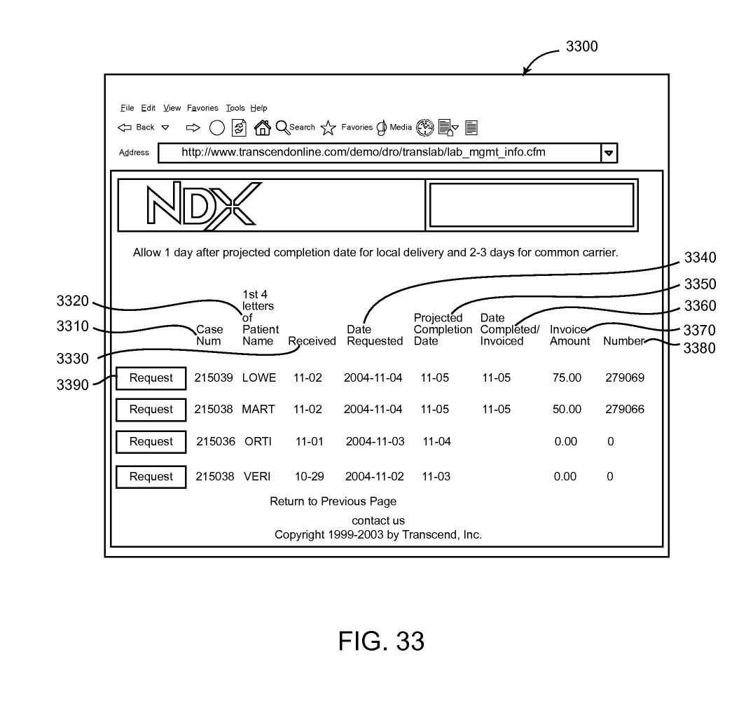

In reference to FIG. 33, the system 100 is configured to display Screen 3300 to a user which reveals summary case status information comprising case number 3310, patient name 3320, date Received 3330, Date Requested 3340, Projected Completion Date 3350, Date Completed or Invoiced 3360, Invoice Amount 3370 and Invoice Number 3380. Such data is a product of the system's laboratory management services.

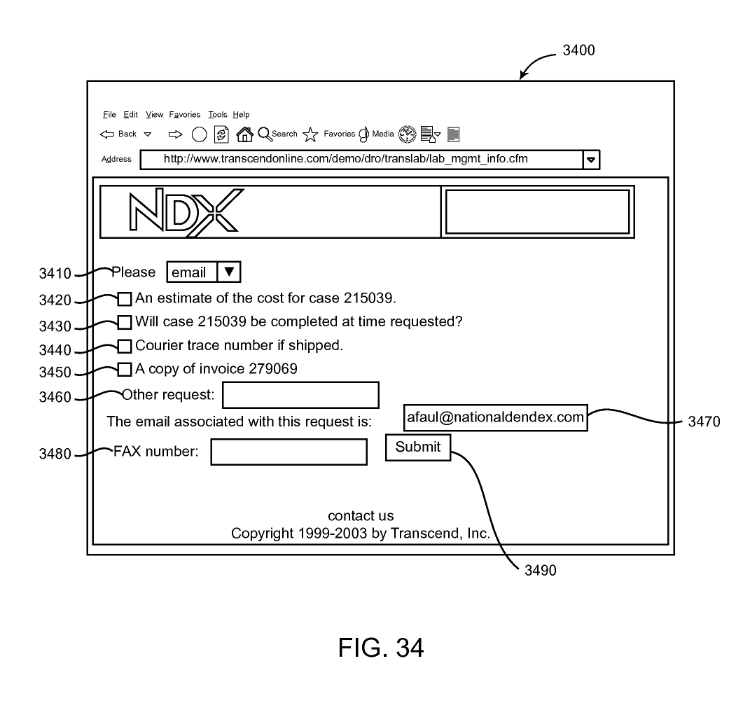

In reference to FIG. 34, the system 100 displays a screen 3400 to a user which allows the user to select case status data to comprising; an estimate of cost for a given case 3420, completion time status 3430, courier trace number or other data requests 3460. The user also may choose the medium 3410 by which the system is to communicate the data and data pertinent to a medium comprising email address 3470 and fax number 3480.

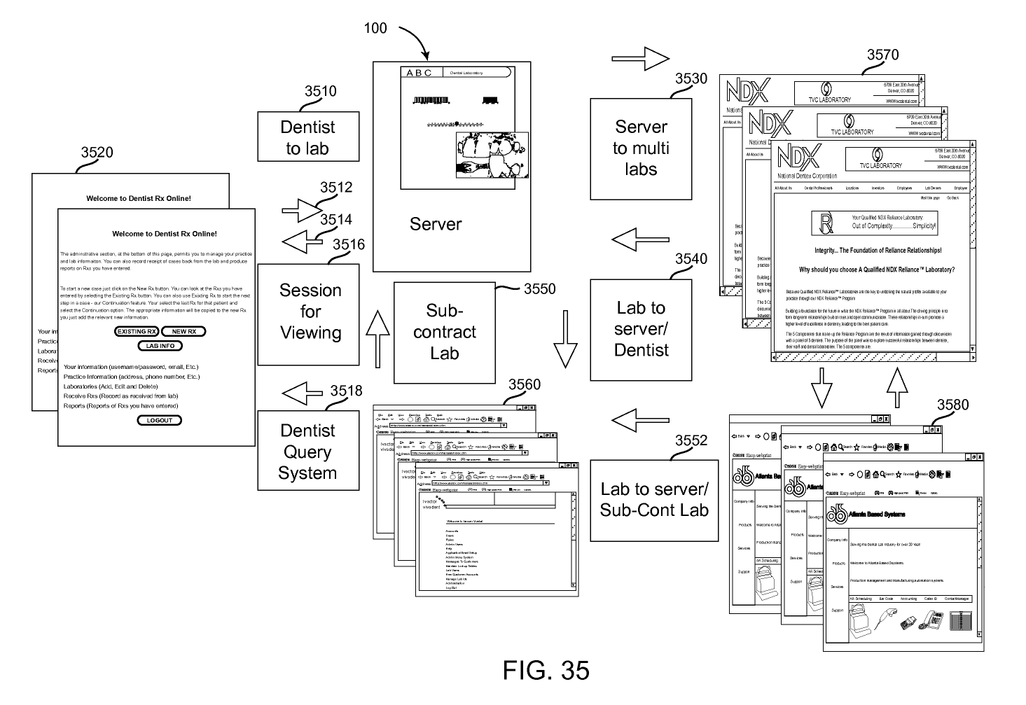

In reference to FIG. 35, the system 100 is configured to provide services comprising: communication services from dentists to laboratories 3510, from laboratories to dentists 3540, and from laboratories to subcontractors 3542. Thus the system permits laboratories to integrate outsourced subcontractors into the prosthetic fabrication process.

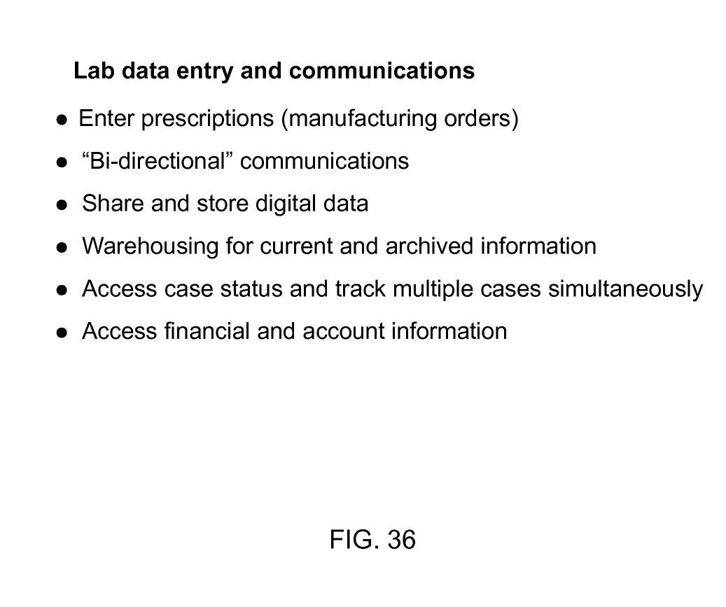

FIG. 36 lists a number of features that may be incorporated into the various embodiments of the present invention.

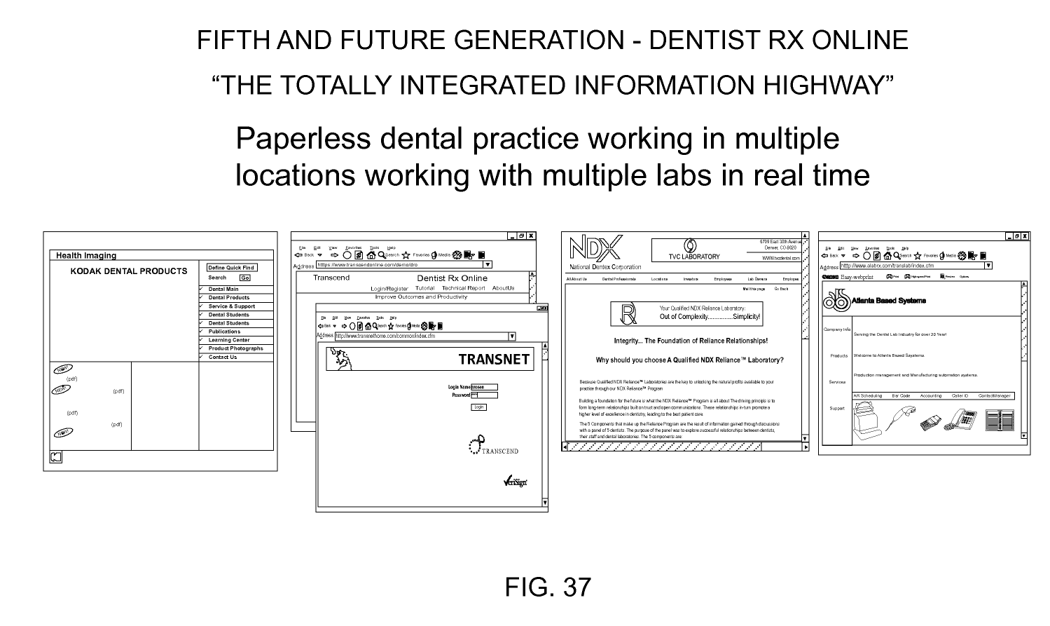

FIG. 37 represents the feature of some embodiments of the present invention in which the system allows the use of a paperless dental practices working in multiple locations and working with multiple labs in real time. In essence, all of the records of the entire dental practice and of all of the various labs and other functions are stored online in digital form and readily available to all authorized personnel.

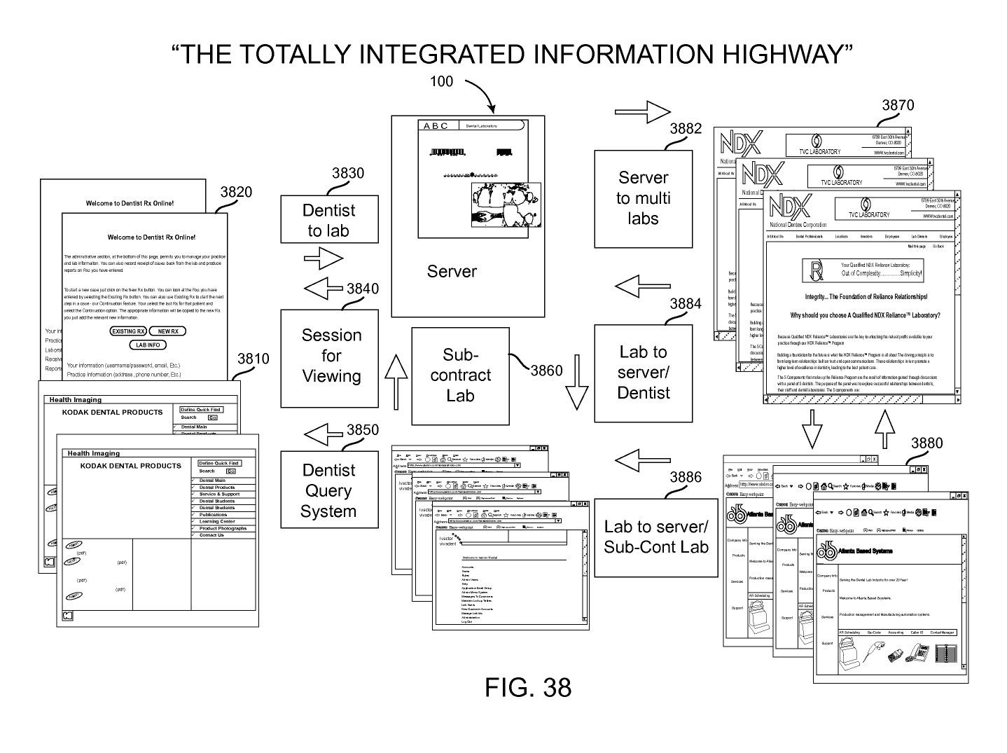

In reference to FIG. 38, the system 100 provides integrated communication services comprising: multiple dentists 3830 communicating with multiple laboratories, multiple laboratories communicating with multiple subcontractors 3886, and multiple subcontractors in direct communication with the system 3860.

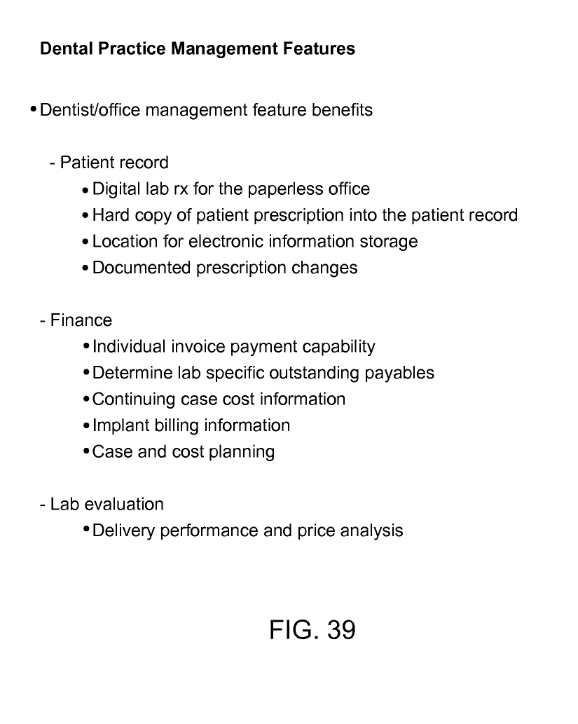

FIG. 39 lists various dental practice management features that may be incorporated into the various embodiments of the present invention.

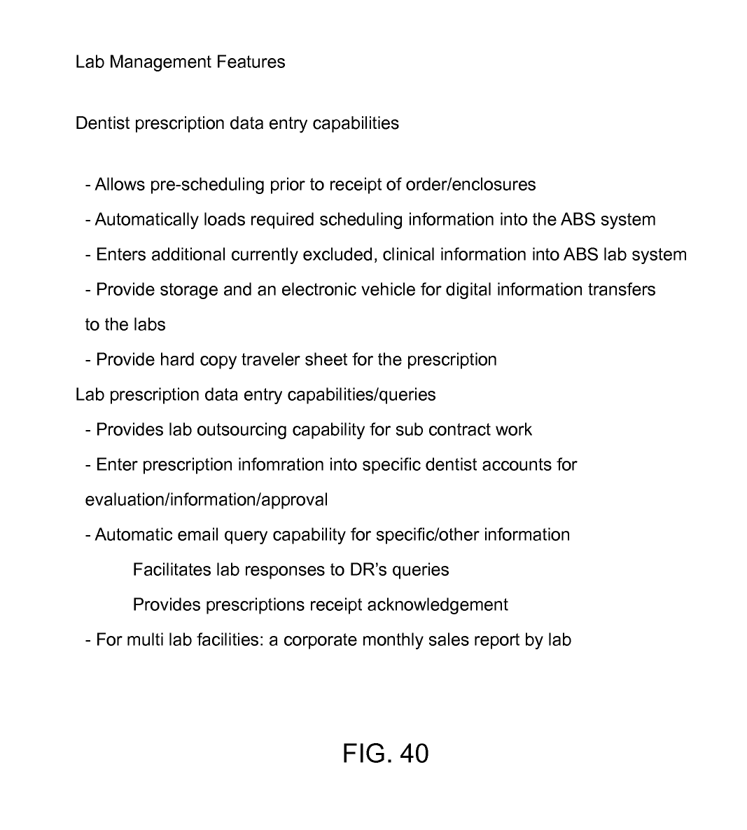

FIG. 40 lists various dental lab management features that may be incorporated into the various embodiments of the present invention.

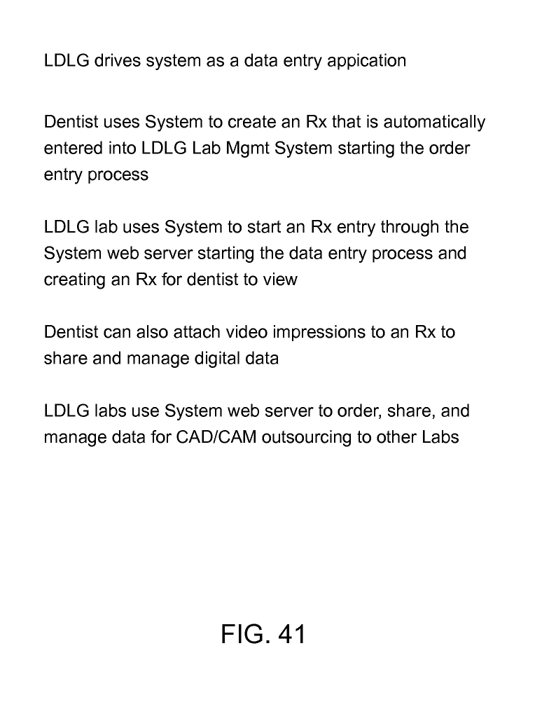

FIG. 41 shows the various steps and features that can be used by a large dental lab group (designated LDLG), employing the system as a data entry application.

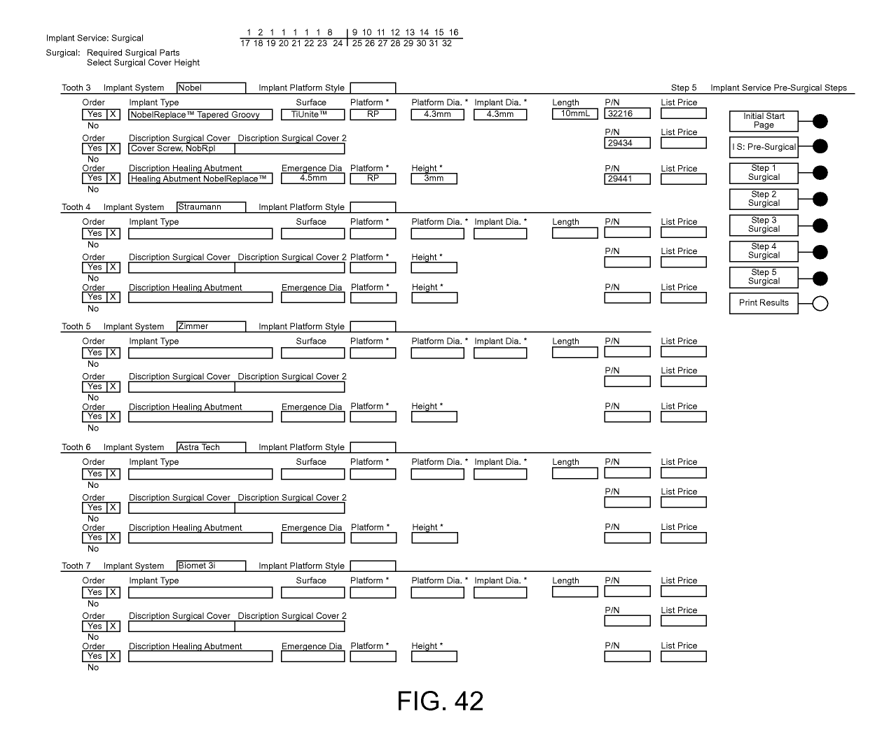

FIG. 42 presents a flowchart associated with embodiments of the present invention directed specifically to the field of dental prosthetics and dental implants.

The field of dental prosthetics and dental implants is a growing activity involving constantly improving clinical techniques, manufacturing techniques, and products. In dental patient care, a primary care dentist may or-may not be the clinical decision maker in all of the phases of a patient's prosthetic work. A primary care dentist's expertise may not be complete enough to decide all aspects and selections necessary for a patient's needs. Additional individuals from various disciplines may be needed to specify ancillary components necessary to complete prescription information to satisfy a dental patient's requirements.

Pre-prescription prosthetic work by outside physicians, started at the request of the primary care dentist, bears greatly on final prescription specifications, requirements and patient results. Pre-prescription work may be done by oral physicians, prosthodontists, or other dentists. In addition other specialty physicians may select additional prosthetic components, and perform temporary and/or permanent work on a patient as part of the normal prosthetic process. Implants and their surrounding tissue preparation would, for example, directly influence follow-on prosthetic efforts and subsequent lab prescriptions. In addition, prescription work requested from laboratory specialists, usually decide the final optimum prosthetic prescription components and configurations necessary for proper prosthetic outcomes. This is due to their extensive knowledge in prosthetic manufacturing requirements and opinions generated from physician-supplied mold transfer information. Accordingly, there is a need for some degree of collaboration in the clinical decision process and choices performed by these requested physicians/experts and laboratory specialists with the original primary restorative dentist.

All these and other activities need to be linked together to indicate the total related instructions, components and disposable parts associated with the creation of prosthetics and final restorative efforts in a patients care—This information and action along with the physician prescriptions and laboratory selected components constitute significant portions of a prosthetic process.

A number of features become particularly significant in applying the principles of the present invention to this specific process as is set forth following:

The process is a query based procedure using a step by step flow of clinical questions and answers that guide physicians and technicians to optimum part selections required for prosthetic work from various categories of available vendor items. Selections are made based on individual patient requirements coupled with the knowledge of the physicians or laboratory specialists on the different aspects of the desired prosthesis. This process, at the discretion of a restorative dentist, can be used by all of a restorative dentist's service groups to create a contiguous information database including information prior to initial prescription creation, alterations and changes during prescription manufacture, and final completion prescription efforts required by dental patients.

This process can be used in a collaborative effort involving multi-disciplined groups consisting of outside physicians/experts, and dental laboratory specialists to support primary care physicians. Using the process, the primary care dentist can indicate his preferences for some, or all the clinical prosthetic related work performed by outside physicians/experts, and laboratory specialists. Final choices are discussed between the primary care physicians and outside physicians/experts, or dental laboratory specialists and the results are entered/recorded in the prescription system for accurate prosthetic information and further prescription work. All parties have access to the query based selection process for use in parts selection. A continuous record of all the final selections by all the final decision makers is part of the prosthesis prescription process.

Clinical decisions are made by different individuals along the entire prosthetic process. There is no specific dividing line between where clinical decisions are made by outside physicians/experts verses made by the primary care dentist. Outside physicians/experts clinical decisions are made solely at the request of the primary care dentist and he decides where their expertise best apply to his patient's prosthetic needs. The primary care dentist activates the prosthetic process by starting a dental patient's service for a new prosthetic. (If dental implants are required then a multiservice process ensues consisting of pre and post-surgical, and prosthetic prescription work) The restorative dentist then selects his desired support groups and allows them access to the patient's prescriptions and associated service activities, prior to, during, and after prosthetic work.

When applying the principles of the present invention to the development of dental prosthetics, a number of features, as shown following, become particularly significant.

The present invention enables appropriate vender component information comprising vendor names, part descriptions, part numbers, list price, color, size, and component inter-relationships to be added to a prescription.

The present invention communicates to a laboratory selected to do work on part or all of the patient prosthesis, vendor component information needed by a laboratory to complete the assigned prescription work comprising: vendor names, part descriptions, part numbers, list price, color, size, and component inter-relationships.

The present invention communicates to a physician selected to do work on part or all of the patient prosthesis effort, vendor component information and expendables information, needed by a physician to complete the assigned portion of the prescription work and comprising; vendor names, part descriptions, part numbers, list price, color, size, component inter-relationships.

The present invention communicates to a primary care dentist, vendor information and expendables information, needed by a primary care dentist to complete the assigned portion of the prosthetic work, comprising: vendor names, part descriptions, part numbers, list price, color, size, and component inter-relationships.

The present invention communicates a chair side check list of vendor material components and vendor disposables needed to support the creation of a prosthetic device for a dental patient. This information is available to a process-originating primary care dentist as well as outside physicians granted access by the process-originating primary care dentist.

The present invention provides services to enable a collaborative effort of multiple people from multiple disciplines at multiple stages to enter, store, update, communicate and archive complete prescription information, and pre-prescription work for the prosthesis.

The present invention communicates pre-prescription and prescription work information to and from other collaborative physicians involved in a patient's care, comprising oral surgeons, prosthodontists, endodontists, pedodontists, and dentists.

The present invention provides to a physician a vendor component parts list of required items, including consumables, needed to complete a patient's prosthesis. These components along with the prescription generated lab product are used in the completion of the prosthetic service.

The present invention provides a selection process to define criteria needed to select vendor component parts necessary in the planning, creation and completion of patient prosthetic services.

The preferred embodiment of the present invention comprises the following features:

An expert system designed to integrate clinical decision making with the subsequent manufacturing of related prosthetic appliances;

A process to guide dental professionals along pathways to manage selection and integration of components required for successful implant surgical procedures as well as design options and complementary component selections for the manufacturing of related prosthetic appliances;

Multipoint network with the purpose of connecting any number of dental professionals, in any number of locations, to diagnose, case plan, and, design, order, and manufacture dental prosthetic devices;

An expert system designed to provide the artificial intelligence to dental professionals comprising the vast body of information surrounding component selection and options for successful dental implant surgical and prosthetic treatment;

An expert system designed to provide collaboration in the planning, design, order, and manufacturing of dental prosthetic appliances and;

A per-tooth process addition/enhancement of the original application.

A dentist, unable to make clinical decisions concerning implant components, may leave the decision process to selected laboratory specialists. The specialist is required to evaluate implant vendor products using conventional methods comprising catalogs and charts. In the present invention, at the requesting dentist's discretion, the specialist can utilize the process comprising: retrieving the original prescription, continuing to select prosthetic components, completing missing prescription items and including the selections in the final prescription documentation. In addition manufacturing components and disposables used in the process of creating the prosthetic can also be selected, thereby reducing the specialist's time and effort in acquiring necessary information.

The process of the present invention includes vendor component list prices and individual originating restorative dentist appropriate discounts which can be used together to compare and select the most cost effective prosthetic solutions and make the selected laboratory specialists aware of not only the desired clinical outcomes but some of the most cost effective clinical components that the originating restorative physician wants for the prescription prosthetic. Some cost considerations by the originating restorative dentist when selecting components comprise: material considerations, Third-party interchangeable components, dentist supplied parts, and alternate fabrication techniques.

The process of the present invention with its multi implant vendor selection capabilities creates an opportunity to evaluate different clinical and financial alternatives for a restoration utilizing the same selection method for equivalent prosthetic ancillary and primary components, necessary for the restorative process prior to generation of the prosthetic prescription. This process thus improves overall financial and clinical results.

It is obvious that minor changes may be made in the form and construction of the invention without departing from the material spirit thereof. It is not, however, desired to confine the invention to the exact form herein shown and described, but it is desired to include all such as properly come within the scope claimed.

The invention having been thus described, what is claimed as new and desired to secure by Letters Patent is:

1. A computer implemented method of ordering a dental prosthetic from a dental laboratory, the method comprising:
receiving, at a server system, a prescription for a dental prosthetic for a patient;
receiving, at the server system, a request for expert guidance about the prescription;
sending, from the server system, the request for expert guidance to a computing device associated with an expert;
receiving at the server system, the expert guidance;
sending from the server system, the prescription to a dental laboratory; and wherein
a dentist is provided access to expert collaboration to assist in specifying the dental prosthetic.

2. The method of claim 1 wherein the step of receiving further comprises data entered into a prescription entry form.

3. The method of claim 1 further comprising updating the prescription in response to the expert guidance.

4. The method of claim 1 further comprising storing the prescription.

5. The method of claim 1 wherein the step of receiving further comprises receiving an image of a tooth of the patient.

6. The method of claim 1 further comprising processing a query seeking data associated with one of the patient and the prescription.

7. The method of claim 1 further comprising separately storing and retrieving at least one of: digital image files, digital CAD/CAM files, and digital dental color files.

8. The method of claim 1 wherein the step of receiving further comprises receiving a prescription from a dentist.

9. The method of claim 1 wherein the step of receiving further comprises receiving a prescription from a laboratory.

10. The method of claim 1 wherein the step of receiving expert guidance further comprising a plurality of experts in various aspects of dental prosthetics, the experts collaborating to advise on an aspect of the prescription.

11. A networked based system for ordering a dental prosthetic from a dental laboratory, the system comprising:
a computer processor having computer memory coupled thereto; the processor configured to:
receive a prescription for a dental prosthetic for a patient;
communicate a request for guidance about the prescription to an expert; receive the requested expert guidance; communicate the prescription to a dental laboratory; and wherein
a dentist is provided access to expert collaboration to assist in specifying the dental prosthetic.

12. The network-based system of claim 11 wherein the processor is further configured to receive data entered into a prescription entry form.

13. The network based system of claim 11 wherein the processor is further configured to update the prescription in response to the expert guidance.

14. The network based system of claim 11 wherein the processor is further configured to store the prescription in computer memory.

15. The network based system of claim 11 wherein the processor is further configured to receive an image of a tooth of the patient.

16. The network based system of claim 11 wherein the processor is further configured to receive a query seeking data associated with one of the patient and the prescription.

17. The network based system of claim 11 wherein the processor is further configured to further separately store and retrieve at least one of: digital image files, digital CAD/CAM files, and digital dental color files.

18. The network based system of claim 11 wherein the processor is further configured to receive the prescription from a dentist.

19. The network based system of claim 11 wherein the processor is further configured to receive the prescription from a laboratory.

20. The network based system of claim 11 wherein receiving expert guidance further comprises receiving guidance from a plurality of experts in various aspects of dental prosthetics, the experts collaborating to advise on an aspect of the prescription.
